(19) United States
(12) Patent Application Publication
(10) Pub. No.: US 2025/0378152 A1
(43) Pub. Date: Dec. 11, 2025

(54) SYSTEMS AND METHODS FOR AUTHENTICATING THE PROVENANCE OF GENERATIVE WORK

(71) Applicant: Human Intel Institute, Portland, OR (US)

(72) Inventors: Ned D. Hayes, Portland, OR (US); Devin F. Gaffney, Portland, OR (US)

(21) Appl. No.: 19/233,989

(22) Filed: Jun. 10, 2025

Related U.S. Application Data
(60) Provisional application No. 63/658,375, filed on Jun. 10, 2024.

(51) Int. Cl. G06F 21/32

(52) U.S. Cl. CPC G06F 21/32

(57) ABSTRACT

A system and associated method for authenticating the provenance of a work is configured to determine whether a work is created by a natural person, generative machine systems such as artificial intelligence (AI) and/or large language model toolsets, or a combination of both human and synthetic systems. The system includes a plurality of software tools running on a data processing system configured to validate an identity of a human creator, receive an attestation from the natural person claiming authorship of a work, and determine to what degree the work is human-created. The system is configured to determine whether the work is human-created by corroborating attestations made by the claimed human creator and utilizing an algorithmic process that analyzes the work to attempt to detect synthetic generated content and analyzes a generative process of the work-in-question to determine whether the generative process can be accurately described as a human generative process.

### CROSS-REFERENCES

The following applications and materials are incorporated herein by reference, in their entireties, for all purposes: U.S. Provisional Patent Application Ser. No. 63/658,375, filed Jun. 10, 2024.

### FIELD

This disclosure relates to systems and methods for authenticating work provenance and distinguishing between synthetic work created by machine ingestion and extrusion and work created by a natural person using human agency.

### INTRODUCTION

The use of natural language processing (NLP) machine systems to create mathematical models of existing human work at great scale gave rise to large language models (LLMs). In turn, language modeling systems have now been used as machine-driven toolsets to ingest and analyze a large volume of human-made material and create additional models of such work. These LLM systems then use the ingested material and resulting models to extrude and generated synthetic works, yet all of the resulting work is derived from the patterns found in the original human-made work. Nothing within the LLM systems in market today are original to that system: at the present time, all data extruded from such systems is derivative. Yet the ability of these so-called “Artificial Intelligence” (AI) systems to generate work which seems-on a surface level, at the very least-to be commensurate with and comparable in style and form to human-made work has allowed a variety of business organizations to encourage many people to use such language modeling systems to generate synthetic works. This marketplace dynamic has resulted in the creation of a vast and growing amount of synthetic and artificially generated work. As a result, it has become increasingly rare to find work which does not contain at least trace elements of artificially-generated content. Genuine human-created work has thus become of high value to businesses who deploy artificial intelligence (AI) systems, as well as those who use such language modeling services, human copyright holders, those who wish to provide renumeration to human copyright holders, and many other players with both financial and moral interest in generative work products.

### SUMMARY

The present disclosure provides systems, apparatuses, and methods relating to provenance authentication for a generative work.

In some examples, a system for authenticating provenance of a work may include: a server including a server memory and one or more server processors; a client device in communication with the server over a communication network; and a software program including a plurality of instructions stored in the server memory and executable by the one or more server processors to: validate an identity of a natural person creator; receive an attestation from the natural person creator claiming authorship of the work; and determine whether the work is human-created without use of synthetic machine work-generation toolsets, wherein determining whether the work is human-created includes: analyzing the work to identify indicators of synthetic machine generation; and analyzing a generative process of the work to identify indicators of a human generative process of the work.

In some examples, a method of authenticating provenance of a work may include: utilizing one or more processors of a data processing system to: validate an identity of a natural person creator; receive an attestation from the natural person creator claiming authorship of the work; and determine whether the work is human-created without the use of synthetic machine work-generation tools by: analyzing the work to identify indicators of synthetic machine generation; and analyzing a generative process of the work to identify indicators of a human generative process of the work.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative work provenance authentication system in accordance with aspects of the present disclosure.

FIG. 2 is a schematic block diagram illustrating components of the work provenance authentication system of FIG. 1.

FIG. 3 is a flow chart depicting steps of an illustrative method for authenticating the provenance of a work in accordance with aspects of the present disclosure.

FIG. 4 is a flow chart depicting steps of an illustrative method for validating the identity of a natural person creator in accordance with aspects of the present disclosure.

FIG. 5 is a flow chart depicting steps of an illustrative method for detecting synthetic machine generated content within a work in accordance with aspects of the present disclosure.

FIG. 6 is a flow chart depicting steps of an illustrative method for analyzing a generative process of a work to detect a human generative process in accordance with the present disclosure.

FIG. 7 is a schematic diagram of an illustrative data processing system in accordance with aspects of the present disclosure.

FIG. 8 is a schematic diagram of an illustrative network data processing system in accordance with aspects of the present disclosure.

### DETAILED DESCRIPTION

Various aspects and examples of a work provenance authentication system, as well as related methods, are described below and illustrated in the associated drawings. Unless otherwise specified, a work provenance authentication system in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Work” is a broad term used herein to describe any material, content, product, artifact, extruded output, or other resulting object, design or concept that was generated by any extant means of production-either machine-driven or effected by direct or in-direct human agency. “Works” may be variously described as “creative” or “substantial”, but all work described herein has a means of generation and results in an object with a digital or physical presence in the world which can be locked to a particular moment in time and space. This meaningful continuing presence in the world is an attribute of “work” which is important for the means of provenance identification described herein.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, systems and methods for authenticating provenance of a work in accordance with the present teachings are configured to validate an identity of a natural human person who claims authorship of a work (e.g., text, images, illustration, music, audio, film, video, etc.) and analyze the work to determine whether the work is human-created and does not include elements generated by synthetic machine work-generation tools, language modeling systems and/or any other machine-driven systems. Based on the identity validation coupled with the comprehensive analysis of the work performed by the system, the system is configured to calculate and output one or more confidence scores indicating a likelihood that the work is human-created and/or that the work does not include synthetic machine generated elements. The system is further configured to generate documents (e.g., certificates) certifying that the work is human-created to a degree of confidence by the identified natural person.

Provenance authentication systems of the present disclosure may include software and/or hardware configured to validate the identity of the natural person who generated the work (AKA the natural person creator or human creator), analyze the work itself, and/or output the one or more confidence scores and/or documents certifying a natural person as the author of the work and that that named specific natural person created the work without using generative artificial intelligence (AI) tools. For example, the provenance authentication system may include a plurality of software programs, modules, and/or applications running on a server, a client device, and/or any other suitable data processing system that are configured to validate the identity of the alleged natural human creator, generate and/or receive an attestation from the natural person claiming authorship of the work, and/or analyze the work to determine whether the work is human-created without including synthetic or artificially generated content. One or more of the software programs, modules, and/or applications may comprise one or more trained machine learning models (e.g., large language models, computer vision models, etc.) configured to perform one or more of the actions or calculations of the systems and methods discussed herein.

In some examples, the provenance authentication system is configured to determine whether the work is human-created both by analyzing the work to determine whether the work includes synthetical machine generated content and by analyzing a generative process of the work to determine whether the generative process is indicative of a natural person who was the human creator. Thus, the provenance authentication system is not only configured to detect aspects of the work generated by synthetic means, but also configured to detect genuine evidence of human generation of the work. For example, the provenance authentication system may include process tracking software program(s) configured to monitor the generative process of the work. Natural human persons have a distinct work generation process that is often nonlinear and typically involves a large number of revisions, edits, and intermediate drafts before completing the final version of a work. In contrast, language modeling and so-called “artificial intelligence” systems do not disclose access to their generative processes in ways that can be observed by anyone without low-level administrative access to the inner workings of the language modeling system. Without such low-level administrative access, externally observed machine systems have not been observed to create work products that exist at points in time and have certain identifiable stages, such as an initial draft, re-draft, and final version. In some examples, the system described herein is configured to monitor the generative process of the work by capturing one or more intermediate versions (e.g., drafts) of the work and/or any other suitable input data, such as keystroke-level input data input into a word processor by a natural person. In some examples, the process tracking software includes a word-processor plugin or extension configured to capture the keystroke-level changes and/or intermediate drafts of a written work input into a word processor. In some examples, the system is configured to utilize the captured input data or intermediate drafts of the work to calculate one or more delta values indicating the level of textual change (e.g., character, word, sentence, paragraph-level changes), semantic change, structural change, and/or change in typing patterns (e.g., typing velocity variance, pause distributions, number and character of edits and reversals, etc.) throughout the generative process of the work. In some examples, the system is configured to determine to a certain level of confidence whether the work was generated using a human generative process, and therefore was generated by a natural person, based on the analysis of the generative process and the calculated delta values.

Technical solutions are disclosed herein for positively verifying and authenticating a work as created by a natural person without including synthetic or artificially generated content. Specifically, the disclosed system/method addresses a technical problem tied to synthetic generation models, namely the technical problem of determining whether works are generated solely by machines, are generated by natural persons, or contain aspects that demonstrate a combination of both types of generative activities. The system and method disclosed herein provides an improved solution to this technical problem by utilizing a plurality of algorithmic and/or machine-driven tools to analyze the work to not only detect the presence or absence of synthetic machine generated content within the work, but also to gather and verify genuine evidence of human creation by a natural person, such as determining that the work was created using a human generative process. This allows the system to not only verify that a work contains or does not contain synthetic content, but further to positively verify that the creative work is human-created by a natural person.

The disclosed systems and methods provide an integrated practical application of the principles discussed herein. Specifically, the disclosed systems and methods describe a specific manner of validating the identity of a natural person who claims authorship of the work and determining whether the work is in fact human-created and does not contain synthetic or machine-generated content. This provides a specific improvement over prior systems and results in an improved system and method for certifying a work as verifiably human-created by a natural person. Accordingly, the disclosed systems and methods apply (or use) the relevant principles in a meaningfully limited way.

Aspects of work provenance authentication systems and methods may be embodied as a computer method, computer system, or computer program product. Accordingly, aspects of the provenance authentication systems and methods may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the provenance authentication systems and methods may take the form of a computer program product embodied in a computer-readable medium (or (media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of work provenance authentication systems and methods may be written in one or any combination of programming languages, including an object-oriented programming language (such as Java, C++), conventional procedural programming languages (such as C), and functional programming languages (such as Haskell) and other languages and ways of generating programmable modules which have not yet hitherto been described in the technical literature. Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the provenance authentication systems and methods may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the provenance authentication systems and methods. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of illustrative work provenance authentication systems as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Provenance Authentication System

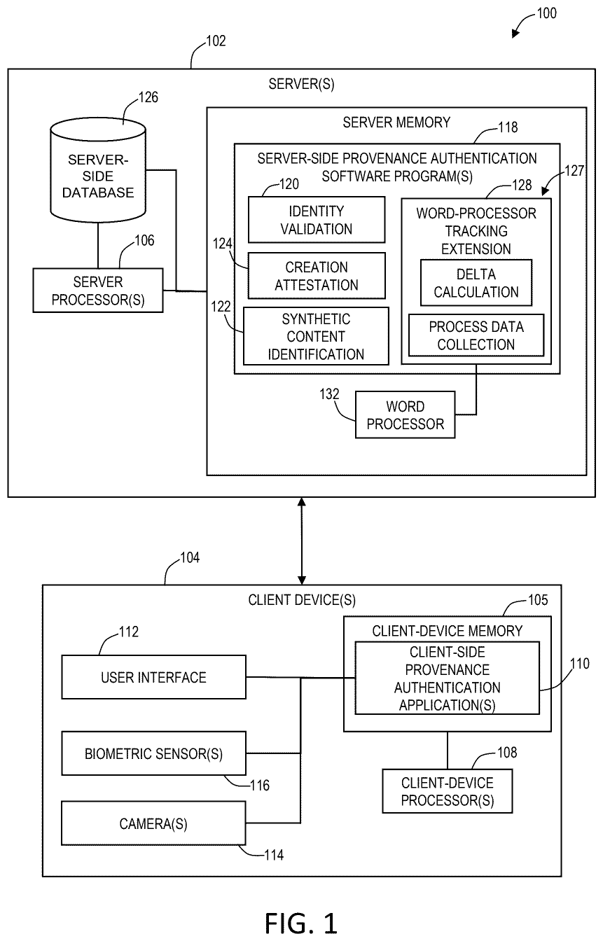

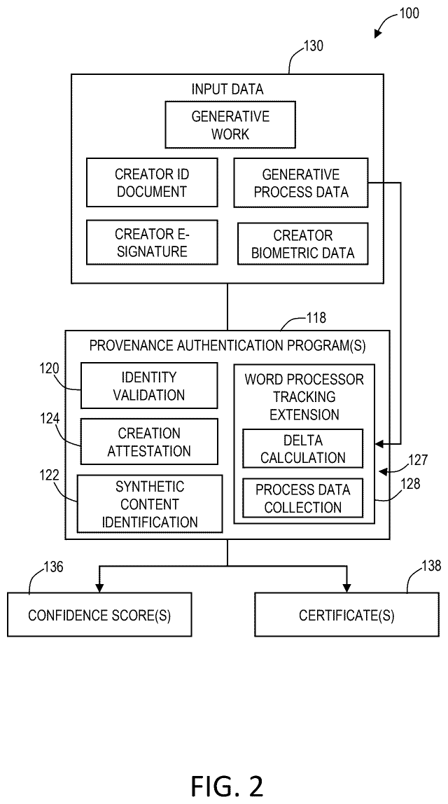

As shown in FIGS. 1-2, this section describes an illustrative provenance authentication system 100 configured to determine and certify the origin of a work. Provenance authentication system 100 is an example of the systems and methods for authenticating the provenance of work described above in the Overview.

With reference to FIGS. 1 and 2, provenance authentication system 100 is configured to certify the provenance or lineage or origin of work (e.g., human provenance or synthetic provenance) including creative work and art forms of various mediums including text, images, illustrations, music, audio, film, video, etc. Provenance authentication system 100 is configured to certify the provenance of the work by verifying the identity of a human creator (AKA a natural person creator) who is a natural person that claims authorship of the work and analyzing the work to verify that the work is human-created without including a majority of artificially or synthetically generated elements, such as a majority of elements that are generated by synthetic machine work generation tools, (e.g., language modeling systems and/or any other generative machine learning system, artificial intelligence (AI) toolsets, natural language processing engines, and/or related systems that function to create synthetic material similar to human output).

As shown in FIG. 1, in some examples, provenance authentication system 100 includes one or more servers 102 and one or more client devices 104 in communication with server(s) 102 (e.g., via a computer network). Client device 104 may comprise a mobile device (e.g., a smart phone), a personal computer, and/or any other suitable device(s) capable of wireless communication with server(s) 102 and configured to execute software programs. Server(s) 102 may comprise any suitable server computer and/or cloud-based server configured to communicate with client device 104 and that is configured to execute software programs. Provenance authentication system 100 includes a plurality of software applications, modules, and/or programs implemented on one or more of server(s) 102 and/or client device 104 that are configured to be executed by one or more server processor(s) 106 of server(s) 102 and/or one or more client-device processor(s) 108 of client device 104 to perform one or more the actions or tasks, discussed herein.

For example, provenance authentication system 100 includes one or more client-side provenance authentication applications 110 (AKA client-side applications) running on client device 104 that are configured to facilitate receiving data from a user of client device 104, transmitting data to server(s) 102, and receiving data from server(s) 102. Client-side application(s) 110 include a plurality of instructions configured to be executed by one or more client-device processor(s) 108 to perform one or more actions, calculations, or tasks. Client-side application(s) 110 may comprise one or more web-based software application(s) that are accessible via a web browser running on client device 104 and/or one or more native software application(s) stored directly on client device 104. In some examples, the plurality of instructions of one or more client-side application(s) 110 are stored in a server-side database 126 and client device 104 is configured to request, receive, and execute the plurality of instructions of client-side application(s) 110 from server 102. In some examples, one or more of client-side application(s) 110 include instructions stored in a client-device memory 105 of client device 104 that are configured to be executed by client-device processor(s) 108. In some examples, client-side application(s) 110 are configured to control visual elements displayed on a user interface 112 of client device 104 to prompt user inputs and/or actions using client device 104. For example, client-side application(s) 110 may be configured to prompt a user to input data via user interface 112, such as images, videos, scans of identity documentation, e-Signatures, biometric data, the work, and/or intermediate draft(s) of the work. In some examples, client device 104 includes one or more camera(s) 114, biometric sensor(s) 116, and/or any other suitable sensor(s) (e.g., cameras, facial recognition sensors, fingerprint scanners, etc.) configured to capture input data from a user, such as facial scans, fingerprint data, images or videos of the user, scans of identity documentation, etc. In some examples, the user of the client device 104 comprises the natural person who is claiming authorship of the work. In some examples, client-side application 110 is configured to facilitate a video call between the natural person who is claiming authorship of the work and a certified individual who is configured to facilitate an identity verification process over the video call, as discussed further below. Client-side application(s) 110 are configured to transmit the received input data to server(s) 102 for further analysis and processing. In all of these cases, the information generated contributes to an overall data profile which can be used to provide a scoring ratio.

Provenance authentication system 100 includes one or more server-side provenance authentication software programs 118 (AKA server-side software programs) running on server(s) 102 that are configured to receive data from and transmit data to client-side application(s) 110 running on client device 104. Server-side software program(s) 118 include a plurality of algorithmic and/or AI tools that are configured to utilize the data received from client-side application 110 to validate an identity of the human creator who claims authorship of the work and to determine whether the work was created in whole or in part by a natural person or by a generative computer mechanism, such as a large language model (LLM). For example, server-side software program(s) 118 may include one or more server-side software programs, modules, and/or applications configured to be executed by server processor(s) 106 of server(s) 102 to validate an identity of a natural person (e.g., using the biometric data), receive and store an attestation from the natural person claiming authorship of the work, analyze the work to determine whether the work includes a majority of synthetic machine generated elements, and track and analyze a generative process of the work to determine whether the work was created using a human generative process (e.g., a draft-revision process). In some examples, server-side software program(s) 118 include a plurality of instructions or code stored in a server memory 107 of server(s) 102 that are configured to be executed by server processor(s) 106.

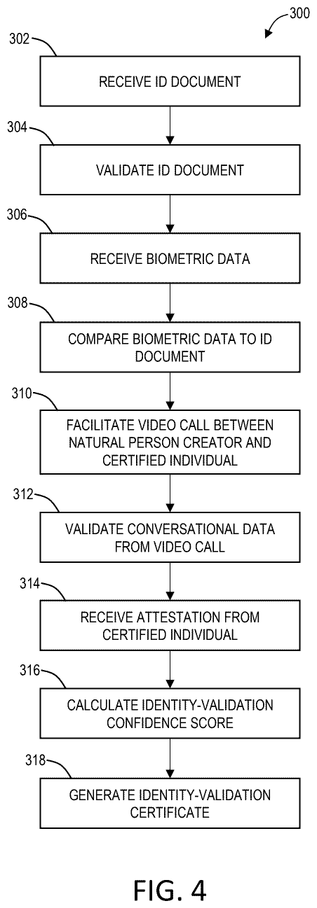

In some examples, server-side software program(s) 118 include one or more identity validation programs 120 configured to validate the identity of the human creator as a natural person having a valid identity. Identity validation program(s) 120 may be configured to validate the identity of the human creator by comparing identity documentation to biometric data of the natural person claiming authorship of the work, analyzing video of the natural person, and/or in any other suitable manner. An example method of identity validation that may be performed by identity validation program(s) 120 of provenance authentication system 100 is further described below with reference to method 300 and FIG. 4. In some examples, provenance authentication system 100 includes multiple identity validation programs 120 each configured to validate the identity of the human creator in a different manner, e.g., based on different input data and/or using a different algorithm. One or more multiple of the different identity validation programs 120 may be utilized to create an overall data profile which can be used to validate the identity of a specific human creator dependent on context.

In some examples, identity validation program(s) 120 are configured to receive a scan of an identity documentation and a facial scan or image of the human creator's face as input and compare the image of the human creator's face to an image in the identity documentation. In such examples, identity validation program(s) 120 may be further configured to validate the authenticity of the identity documentation and/or validate liveliness of the human creator's face in the facial scan or image of the human creator. In response to the facial scan matching the image in the identity documentation and the identity documentation being valid, identity validation programs 120 positively identify the human creator as a natural person having a valid identity. Such identity validation program(s) 120 may utilize computer vision models to analyze the image of the human creator's face and image in the identity documentation, natural language processing (NLP) to analyze text in the identity documentation, and/or any other suitable machine learning models configured to facilitate verifying the identity of the human creator using the image of the natural person and the identity documentation.

In some examples, client-side application(s) 110 and/or identity validation programs 120 may be configured to facilitate and analyze a video call between the human creator and a certified individual to validate the identity of the human creator and/or validate that the human creator is a natural person. For example, client-side application(s) 110 may be configured to facilitate a video call between the certified individual and the human creator using one or more client devices 104. In such examples, the certified individual interacts with the human creator over the video call and may ask the human creator a series of questions, such as personal questions about the human creator(s) family or memories and/or questions about the work the human creator is attesting to have created, such as questions about the process of generating the work in question. In some examples, during the video call, the human creator is asked to verbally attest to having created the work without using synthetic work-generation tools. In some examples, the human creator displays an identity documentation of the human creator to camera 114 of client device 104 during the video call. In some examples, a human being's subjective analysis of the responses to the questions asked (i.e., grading or otherwise charting the responses by the interviewer) constitute a portion of the data that contributes to the overall data profile that is generated to provide a scoring output which verifies the status of the natural person.

In some examples, automated client-side application(s) 110 and/or identity validation program(s) 120 are configured to analyze the video call to validate that the human creator is a natural person having a valid identity. For example, client-side application(s) 110 and/or identity validation program(s) 120 may be configured to analyze the video of the human creator to detect human breathing, eye movement, heartbeat, etc. In some examples, client-side application(s) 110 and/or identity validation program(s) 120 are configured to analyze the human creator's speech and answers to the questions to validate that the human creator is a natural person. For example, identity validation program(s) 120 may be configured to receive audio from the video call, transcribe the audio, and analyze the transcript to determine whether the answers given by the human creator appear to be a natural person or not a synthetic simulacrum of a natural person. In some examples, client-side application(s) 110 are configured to facilitate and capture the video of the human creator and transmit the visual and/or audio data of the video call to identity validation program(s) 120 which perform the analysis. Such identity validation program(s) 120 may utilize computer vision models to analyze the video feed of the video call to detect human actions (e.g., breathing, eye movement, etc.) by the human creator, speech recognition models configured to convert speech into text, natural language processing models configured to analyze the text generated by the speech recognition models, and/or any other suitable machine learning models configured to facilitate verifying the identity of the human creator using input data from the video call. In these examples, the automated machine provides information which can be used to constitute a portion of the data that contributes to the overall data profile that is generated to provide a scoring output which verifies the status of the natural person.

In some examples, identity validation program(s) 120 are configured to generate an identity-validation confidence score indicating a likelihood that the human creator is a natural person having a valid identity. For example, identity validation program(s) 120 may calculate the identity-validation confidence score based on the analysis of the identity documentation and the facial scan of the human creator and/or the analysis of the video call between the human creator and the certified individual. In some examples, identity validation program(s) 120 are configured to generate an identity-validation certificate certifying the human creator as a natural person having a valid identity. For example, identity validation program(s) 120 may generate the identity-validation certificate in response to the confidence score being above a threshold level and/or may include the confidence score on the identity-validation certificate. In some examples, server(s) 102 are configured to store the identity-validation certificate in a server-side database 126 of server 102 and/or transmit the generated identity-validation certificate to client device 104 used by the human creator. In such examples, the information stored on the designated servers constitute a portion of the data that contributes to the overall data profile that is generated to provide a scoring output which verifies the status of the natural person.

In some examples, one or more of server-side software program(s) 118 and/or client-side application(s) 110 are configured to facilitate the identified human creator attesting to being the creator of the work. For example, server-side software program(s) 118 may include one or more server-side creation attestation software programs 124 configured to facilitate the human creator providing a written and/or verbal attestation claiming authorship of the work without the use of synthetic work-generation tools. In some examples, client-side application(s) 110 are configured to display a certificate of authorship on user interface of client device 104 and the certificate of authorship includes a signature input field configured to receive an e-Signature from the human creator. In such examples, the human creator may provide a written attestation of creation of the work by inputting signature data into the signature input field using user interface 112. In some examples, creation attestation software program(s) 124 are configured to transmit the certificate of authorship including the signature input field to client-side application(s) 110 and receive the certificate of authorship including the input signature data from client-side application(s) 110 in response to the human creator inputting the signature data. The signed certificate of authorship connects the human creator who was validated by server-side identity validation program(s) 120 to the work. In some examples, the human creator provides a verbal attestation claiming authorship of the work. For example, the human creator may provide the verbal attestation during the video call conducted during the identity verification process discussed above. In some examples, provenance authentication system 100 is configured to store the signed certificate of authorship and/or the video including the verbal attestation from the human creator in a server-side database 126 of server 110.

In some examples, server-side software program(s) 118 include one or more synthetic content identification programs 122 (AKA AI content identification programs) or software analysis tools configured to analyze the work to determine whether the work includes any synthetic machine generated content. For example, after the identity of the human creator is verified by identity validation program(s) 120 and the human creator attests to having created the work without the use of synthetic machine work-generation tools, synthetic content identification program(s) 122 are configured to analyze the work itself to determine whether the work includes synthetically generated content that was generated by a synthetic machine work-generation system. Provenance authentication system 100 may include a plurality of synthetic content identification program(s) 122 each configured to analyze a different aspect of the work and/or configured to be utilized to analyze different types of works. The specific synthetic content identification program(s) 122 utilized by provenance authentication system 100 to analyze a specific work may be dependent on the type of work being analyzed, e.g., whether the work includes text, images, illustrations, music, audio, film, video, etc. In some examples, provenance authentication system 100 is configured to dynamically adjust the specific synthetic content identification program(s) 122 utilized to analyze a specific work based on the type and format of the work.

In some examples, one or more of synthetic content identification program(s) 122 include a language model (LLM) that is configured to analyze the work to identify synthetically generated content, or include deterministic algorithms configured to utilize the language model for such a purpose. For example, synthetic content identification program(s) 122 may be configured to separate the work into a plurality of sections and for a respective section of the plurality of sections, prompt the language model to attempt to output the respective section based on an input including multiple adjacent sections to the respective section without inputting the respective section itself. For example, synthetic content identification program(s) 122 may be configured to separate a text-based work by tokens (e.g., letters or words), sentences, paragraphs, pages, etc. A select one of the sections is chosen and one or more sections that directly precede the chosen section and one or more sections that directly follow the chosen section are input into the language model, but the chosen section itself is not input into the model. The synthetic content identification program(s) 122 prompt the language model to output the chosen section based on the input adjacent sections. If the output of the language model matches or nearly matches the respective section, the respective section is determined to be synthetically generated and/or derivative of an existing work. If the output of the language model does not match or nearly match the respective section, the respective section may be identified as not being synthetically generated or derivative of existing human generated work. In some examples, the above-described process may be repeated for a plurality of the sections to detect if any of the plurality of sections are synthetically generated.

In some examples, one or more of synthetic content identification program(s) 122 are configured to utilize cryptographic hashing to create a digital identifier of the work and are configured to attempt to match the digital identifier of the work against cryptographic hashes of other created works to detect possible plagiarism or re-use of existing content. For example, synthetic content identification program(s) 122 may be configured to generate International Standard Content Code (ISCC) identifiers for the creative work and compare the ISCC identifier of the creative work to the ISCC identifier of existing works to detect potential plagiarism or re-use of content from existing work. The ISCC identifier is generated from the work itself and utilizes similarity-preserving hashes configured to facilitate identifying near-duplicate files to the work. Thus, a comparison between the ISCC identifier of the work and the ISCC identifier of existing works may be utilized to determine if the work is a substantial duplicate of the existing works, even if minor changes have been made to the work in comparison to the existing work.

In some examples, one or more of synthetic content identification program(s) 122 are configured to utilize one or more trained machine learning models configured to analyze the work and detect synthetically generated content within the work. For example, synthetic content identification program(s) 122 may include one or more trained machine learning models configured to distinguish between human-written works and synthetic works. In some examples, synthetic content identification program(s) 122 include one or more trained machine learning models configured to detect digital watermarks, meta data, and/or any other suitable indicators of synthetic content. The one or more trained machine learning models are configured to receive the work as input and detect digital watermarks, meta data, synthetic writing, synthetic images, and/or any other detectable patterns within the work that indicate that the work was created in whole or in part by generative machine systems such as those marketed today as “AI.”

As discussed above, one or all of the synthetic content identification program(s) 122 may be utilized to attempt to detect synthetically generated elements within the work dependent on the type of the work being analyzed. In some examples, synthetic content identification program(s) 122 are configured to output one or more non-synthetic confidence scores indicating a likelihood that the work includes or does not include synthetic content. In some examples, multiple different non-synthetic confidence scores are output by each of the synthetic content identification program(s) 122 utilized to analyze the work. For example, a respective non-synthetic confidence score may be calculated based on the output of the language model in comparison to the respective section, whether the cryptographic hash of the work matches or nearly matches the hash of any existing works, and/or the analysis of the work by the one or more trained machine learning models detects synthetic content within the work. In some examples, a composite or overall non-synthetic confidence score is calculated based on the analysis performed by each of synthetic content identification program(s) 122 used to analyze the particular work. In some examples, synthetic content identification program(s) 122 are configured to generate a non-synthetic-score or certificate certifying that the work does not include synthetic content. For example, in response to the non-synthetic confidence score(s) being greater than or less than a threshold level, one or more server-side software program(s) 118 may be configured to generate the non-synthetic certificate. The non-synthetic certificate may be stored in server-side database 126 and/or transmitted to client device 104.

In some examples, one or more of the server-side software program(s) 118 are configured to monitor a generative process of the work (e.g., in real time or periodically during the process) and determine whether the work was created using a human generative process. As discussed above, humans have a distinctive generative process in comparison to synthetic machine work generative systems. For example, when generating work, humans exhibit irregular pacing, e.g., bursts of input data followed by thinking, revision steps, partial deletion or additionally activities characterized as “editing.” In contrast, language modeling systems and other generative machine tools exhibit consistent speed of generative and work extrusion that do not demonstrate editing or revision that can be externally observed by observers without system-level access. Human creators typically create creative work in a non-linear fashion involving a large number of revisions, edits, and intermediate drafts before completing the final version of a work. In contrast, synthetic generative systems rarely, if ever, create work products in identifiable stages, such as an initial draft, re-draft, and final version. Additionally, natural human persons who create works typically generate a greater variety of incomplete ideas, grammatical errors and typographical errors than synthetic content generation engines. Furthermore, human creators often switch tone and perspective throughout the initial drafts of a written work, whereas synthetic engines such as language modeling systems maintain a consistent voice. Server-side software program(s) 118 are configured to detect these differences to determine whether the work was created by a verifiable natural person.

In some examples, server-side software program(s) 118 include one or more process tracking programs 127 that are configured to monitor the generative process of the work and analyze the generative process to determine whether the generative process is indicative of a human generative process. For example, process tracking program(s) 127 may be configured to capture one or more intermediate drafts of the work and/or any other suitable process data throughout the generative process. Alternatively, or additionally, provenance authentication system 100 may be configured to prompt a user to upload a plurality of intermediate drafts of the work onto client device 104 and client device 104 transmits the plurality of intermediate drafts to server(s) 102 for analysis.

In some examples, process tracking program(s) 127 include a word-processor tracking extension or plug-in 128 that is configured to capture process data input into a word processor 132. In some examples, word-processor tracking extension 128 is a web-browser extension or plugin that is configured to capture data that is input into a browser-based word processor and/or any other suitable application utilized by the human creator to generate the work. In some examples, the process data captured by word-processor tracking extension 128 includes keystroke-level entry data input by the human creator into the word processor when the human creator is creating the work.

The process data captured by word-processor tracking extension 128 may be temporarily stored locally on client device 104 before being transmitted by client device 104 to server(s) 102 for further analysis by process tracking program(s) 127. For example, the process data may be transmitted to server(s) 102 during client device 104 idle periods or at the completion of a work session. In some examples, the process data includes both the keystroke level input data and/or multiple distinct drafts or versions of the work. For example, a draft of the work may be captured at the end of each work session or workday. The generative process for the work may include a plurality of the work sessions or work days each having corresponding process data that may be stored in server-side database(s) 126 to create a record of creation for the work including the keystroke-level entry data, the plurality of intermediate drafts of the work corresponding to the different work sessions, and/or any other suitable process data captured by word-processor tracking extension 128.

Process tracking program(s) 127 are configured to utilize the process data (e.g., keystroke-level entry data and/or intermediate drafts) captured by word-processor tracking extension 128 to determine whether a natural person is creating the work without using synthetic machine work-generation tools. In some examples, process tracking program(s) 127 are configured to calculate one or more delta value(s) based on the process data captured by word-processor tracking extension 128. Each delta value is calculated using different algorithms. For example, process tracking program(s) 127 may calculate one or more textual delta values, semantic delta values, structural delta values, and/or chronological or temporal delta values based on the process data captured by word-processor tracking extension 128. Server-side software program(s) 118 may then calculate a human-process confidence score for the work based on the delta values. The human-process confidence score indicates a likelihood that the work was created by a natural person without the use of synthetic machine work-generation tools based on determining that the work was generated using a human generative process.

In some examples, process tracking program(s) 127 are configured to calculate one or more textual delta values indicating a variation between successive drafts of the work at the character level, word level, sentence level, and/or paragraph level. For example, process tracking program(s) 127 may utilize the Levenshtein distance algorithm and/or Myers difference algorithm to calculate character level textual delta values between successive drafts of the work. The character level textual delta values quantify the number of character level changes that are required to convert one of the drafts into another one of the drafts of the work. In some examples, process tracking program(s) 127 are configured to calculate the Jaccard similarity coefficient between successive drafts to determine a word-level delta value between successive drafts and/or utilize the Smith-Waterman algorithm to calculate sentence-level variation between successive drafts. These specific algorithms are provided as examples only: any other suitable algorithms may be utilized to calculate the textual delta value(s) between the captured intermediate drafts of the work. In some examples, human-created work is expected to show greater variation between successive drafts than work created solely by machine processes. Thus, the textual delta values calculated between successive drafts of the human-created work are expected to be greater than textual delta values that are calculated between multiple versions of work output by a synthetic generation system built on top of a language model such as those seen in an LLM.

In some examples, process tracking program(s) 127 are further configured to calculate one or more semantic delta values based on the process data captured by word-processor tracking extension 128. The one or more semantic delta values indicate semantic drift or meaning changes of the work throughout the generative process. In some examples, process tracking program(s) 127 are configured to utilize transformer embeddings, such as Bidirectional Encoder Representations (BERT) or Robustly Optimized BERT Pretraining Approach (ROBERTa), to generate document vectors for each of multiple successive versions or drafts of the work and calculate the cosine similarity between the different versions using the generated document vectors. The named transformer embeddings are an example and serve as merely one instantiation of such embeddings and do not represent the totality of configurations that can be done within process tracking programs in order to generate document vectors. This process with one or more embeddings may be repeated a plurality of times throughout the generative process of the creative work to measure semantic drift of the work throughout the generative process. In general, human-created work tends to show gradual semantic changes over time, whereas work created by synthetic generation systems and/or language modeling systems language modeling systems tends to show sudden and drastic semantic shifts.

In some examples, process tracking program(s) 127 are further configured to calculate one or more structural delta values based on the process data captured by the word-processor tracking extension 128. The structural delta value(s) may be calculated in any suitable manner and may be utilized to track or quantify paragraph reorganization, formatting changes, citation additions, and/or punctuation changes that are made to the work throughout the generative process. In some examples, process tracking program(s) 127 are configured to compare the structural delta value(s) of the creative work to structural delta value(s) that are calculated for known human-created work and/or structural delta value(s) that are calculated for known synthetically generated work to determine whether the structural changes made to the work throughout the generative process indicate creation by a natural person or a machine system.

In some examples, server-side software program(s) 118 are further configured to track the edits (e.g., the number and character of revisions), typing patterns (e.g., typing velocity variation), and/or pause distributions (e.g., time between user inputs) input by the human creator when creating the work to determine a temporal fingerprint for the work. When generating written works, natural persons tend to exhibit irregular typing patterns, e.g., bursts of inputs separated by pauses and deletions or corrections of previous inputs. In contrast, machine generation systems exhibit consistent generation speed with linear text production (e.g., beginning to end) and minimal mid-sentence corrections. The typing patterns of the human creator may be detected by analyzing the keystroke-level inputs captured by the word-processor tracking extension 128 during the generative process. For example, variation in typing velocity, pause distributions (e.g., the time distribution between user inputs), a revision-timing distribution (e.g., the timing of revisions and/or the number of revisions), and/or any other suitable variables may be determined based on the captured process data and utilized to generate an overall temporal fingerprint for the work. In some examples, a temporal-fingerprint score is calculated by server-side software program(s) 118 based on the temporal fingerprint of the work. The temporal-fingerprint score indicates a likelihood or confidence level that the typing patterns utilized to create the work are indicative of a human creator creating the work, rather than a machine generative system. For example, the temporal fingerprint of the work may be compared to the temporal fingerprint of known human-created work and/or the temporal fingerprint of known synthetic machine generated work to determine whether the typing patterns utilized to create the work are indicative of a natural person engaged in a generation process or, in contrast, a synthetic generation resulting from a machine process.

In some examples, process tracking program(s) 127 are further configured to calculate one or more chronological or temporal delta value(s). In some examples, the one or more chronological delta value(s) quantify differences in typing patterns, edits, pause distributions, and/or the temporal fingerprint discussed above during the creation process of the work by a natural person. For example, differences between the typing pattern and/or temporal fingerprint utilized on different workdays throughout the generative process may be compared to identify discrepancies. If the temporal fingerprint or typing patterns vary widely between different workdays throughout the generative process and/or are similar to typing patterns exhibited by machine systems, the work may be identified as potentially synthetic in whole or in part.

In some examples, process tracking program(s) 127 are configured to calculate one or more confidence scores based on the delta value(s) discussed above. For example, process tracking program(s) 127 may calculate the temporal-fingerprint score, a revision-pattern score, an error-analysis score, a stylistic-variance score, and/or any other suitable confidence scores based on one or more of the delta values and/or the temporal fingerprint of the creative work. For example, the temporal-fingerprint score may indicate a likelihood that the typing patterns and/or temporal fingerprint utilized to generate the work are indicative of generation by a natural person. In some examples, the temporal-fingerprint score is calculated based on the temporal fingerprint and/or the chronological delta values discussed above.

In some examples, process tracking program(s) 127 are configured to calculate a revision-pattern score that indicates the extent to which the work was generated in a non-linear fashion. For example, if the generative process of the work includes multiple incomplete drafts or versions and a large number of revisions and reversals of previous versions are detected throughout the generative process, the revision-pattern score may indicate a high likelihood that the work was generated by a natural person. The revision-pattern score may be based in whole or in part on the textual delta value(s), semantic delta value(s), structural delta value(s), and/or temporal fingerprint(s) of the work discussed above. The presence of multiple distinct incomplete drafts of the work is evidence in and of itself of generation by a natural person, as machine-driven models typically generate complete and coherent initial drafts, which may be revised by the machine into additional complete drafts. In other words, synthetic generation systems tend to complete work in a linear fashion and the outputs of such systems are typically presented in complete form, whereas natural persons tend to generate multiple incomplete versions of the work before delivering a finished work product.

In some examples, process tracking program(s) 127 are configured to calculate an error-analysis score of the work indicating whether the number of grammatical errors and/or typographical errors included in the work is indicative of creation by a natural person. Natural persons have been observed to generate more grammatical errors and typographical errors than synthetic machine engines. The error-analysis score may be calculated based on the number of errors present in the finished work and/or multiple error-analysis scores may be calculated at various stages throughout the generative process of the work.

In some examples, process tracking program(s) 127 are configured to calculate a stylistic-variance score for the work based on changes in tone, voice, etc., throughout the work. Natural persons tend to switch tone or point of view throughout a work more often than synthetic engines, which often maintain a consistent voice. Process tracking program(s) 127 may be configured to detect changes in tone and/or point of view throughout the work and calculate the stylistic-variance score based on the quantity of tone and perspective switches in the work. In some examples, process tracking program(s) 127 include one or more trained natural language processing (NLP) models and/or any other suitable machine learning models configured to detect the grammatical errors, typos, and/or changes in tone or perspective throughout the work in order to calculate the error-analysis and stylistic variance scores.

In some examples, server-side software program(s) 118 are configured to calculate an overall human-process confidence score based on the one or more delta values and/or confidence scores discussed above. The human-process confidence score indicates a likelihood that the work was created using a human generative process, and therefore was created by a natural person and not a machine-generation tool, based on the analysis of the generative process discussed above. In some examples, the overall human-process confidence score is a weighted sum of the temporal-fingerprint score, revision-pattern score, error-analysis score, stylistic variance score, and/or any other suitable confidence scores or the delta values discussed above.

As shown in FIG. 2 and discussed above, provenance authentication system 100 is configured to receive as input the work, generative process data (e.g., draft(s) and/or word processor input data), a valid and authenticated identity documentation of a natural person, an e-Signature from that same natural person, biometric data of the natural person, and/or any other suitable input data 130 and utilize the input data to validate the identity of the human creator as the natural person and determine whether the human creator's work is created by a natural person without including synthetically generated elements. Provenance authentication system 100 includes a plurality of server-side software programs and/or applications 118 that are configured to be executed by server processor(s) of server 102 to analyze the input data to validate the identity of the human creator and determine whether the human creator's work is created by a natural person without including synthetic machine-generated elements. In some examples, input data 130 is input into client device 104 and/or captured by client device 104 and transmitted from client device 104 to server(s) 102. In some examples, provenance authentication system 100 includes process tracking program(s) 127 (e.g., word-processor tracking extension 128) configured to capture intermediate drafts and/or other process data from the human creator when the human creator is generating the work.

Based on the results of the analysis of the work and the human creator performed by the server-side software programs 118, server-side software program(s) 118 are configured to determine whether the human creator who claims authorship of the creative work is a natural person with a valid identity and determine whether the creative work itself was created by a natural person. In some examples, one or more of server-side software program(s) 118 are configured to calculate and output one or more confidence scores 136 indicating a likelihood that the human creator is a natural person and has a valid identity, a likelihood that the work does not include synthetic elements (e.g., the non-synthetic confidence score discussed above), a likelihood that the work was created using a human generative process (e.g., the human-process confidence score discussed above), and/or an overall human-creation confidence score. In some examples, the overall human-creation confidence is based in whole or in part on the non-synthetic confidence score, the human-process confidence scores, and/or the identity-validation confidence score. For example, the overall human-creation confidence score may comprise a weighted average of one or more of the identity-validation confidence score, the non-synthetic confidence score, and/or the human-process confidence score.

In some examples, server-side software program(s) 118 are configured to generate and output one or more certificates 138 or any other suitable documents based on the results output by identity validation program(s) 120, synthetic content identification program(s) 122, and/or process tracking program(s) 127. For example, server-side software program(s) 118 may be configured to generate one or more of an identity-validation certificate certifying that provenance authentication system 100 validated the identity of a natural person as the human creator, a non-synthetic certificate certifying that provenance authentication system 100 did not detect synthetic content in the work, a human-process certificate certifying that provenance authentication system 100 identified a human generative process of the work, and/or an overall human-creation certificate certifying that the human creator is a natural person with a valid identity and that the work is verified to be generated by a natural person without the use of synthetic generation tools. The one or more certificates generated by provenance authentication system 100 may be stored in a server-side database 126 of one or more server(s) 102 and/or transmitted to client device 104 of the human creator.

In some examples, provenance authentication system 100 is configured to generate the human-creation certificate for a particular version of the work at a particular moment in time and space. If the work is modified in any capacity at a later time, the modified work is no longer certified by provenance authentication system 100 and the human-creation certificate output by provenance authentication system 100 does not apply to the modified work. To be certified, the modified work would have to be re-certified by undergoing the analysis process described above to ensure that all modifications made to the work did not add synthetic machine generated material.

In some examples, provenance authentication system 100 is configured to generate a reliable identifier for the certified work, such as a cryptographic hash of the particular version of the work that is certified. The cryptographic hash of the work is configured to be utilized as an identifier of the particular version of the work that is certified by the human-creation certificate. In this context the system may utilize any suitable cryptographic hash configured to have different respective values for any two works if any difference exists between the works. Accordingly, the cryptographic hash of the certified work functions as a reliable identifier, and may be utilized to confirm that it remains unchanged from the originally certified work.

In some examples, publishing companies may utilize provenance authentication system 100 to determine the origin of the works published by the publishing company. For example, publishing companies may require natural person creators to obtain a human-creation certification for their work from provenance authentication system 100 prior to publishing their work. Alternatively, or additionally, the publishing companies may obtain a human-creation certification from provenance authentication system 100 prior to publishing the work. In some examples, publishing companies may display the human-creation certification generated by provenance authentication system 100 along with the work to show the origin of work. This increases audience trust by showing the source of the works published by the publishing company.

In some examples, provenance authentication system 100 is configured to generate one or more physical certificate objects certifying the natural person creator as a natural person having a valid identity and/or a work as being human-generated by the natural person without the use of machine generation tools. For example, provenance authentication system 100 may be configured to additively manufacture (e.g., 3D print) one or more physical certificate objects (e.g., tokens) and provide the physical certificate objects to the natural person creator of the work as a tangible proof-of-generation and physical manifestation of the provenance of generative work. Such physical certificate objects may be optionally worn or displayed by the natural person creator, either in concert with the display of the work itself in a public setting or on the person of the creator.

### B. Illustrative Method for Authenticating Provenance

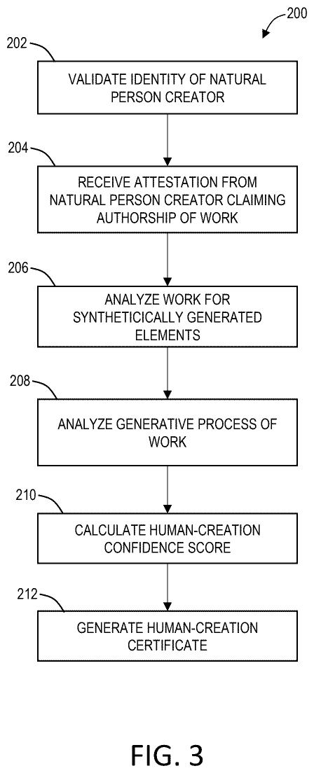

This section describes steps of an illustrative method 200 for authenticating the provenance of work; see FIG. 3. Aspects of provenance authentication system 100 described above may be utilized in the method steps described below. Where appropriate, reference may be made to components and systems that may be used in carrying out each step. These references are for illustration, and are not intended to limit the possible ways of carrying out any particular step of the method.

FIG. 3 is a flowchart illustrating steps performed in an illustrative method, and may not recite the complete process or all steps of the method. Although various steps of method 200 are described below and depicted in FIG. 3, the steps need not necessarily all be performed, and in some cases may be performed simultaneously or in a different order than the order shown.

Step 202 of method 200 includes validating the identity of a human creator. As discussed above, in some examples, server-side software program(s) 118 of provenance authentication system 100 include one or more identity validation programs 120 configured to validate the identity of the human creator. Identity validation program(s) 120 may be configured to validate the identity of the human creator by comparing valid national identity documentations to known national datasets and/or the biometric data of a natural person, analyzing a video feed of the human creator to detect liveliness and/or human speech of the human creator, and/or in any other suitable manner. In some examples, identity validation program(s) 120 are configured to calculate a data profile which is used to create an identity-validation confidence score indicating a likelihood that the human creator is a natural person with a valid identity based on the analysis of the identity documentation, biometric data, and/or video of the human creator. An example method of human creator identity validation that may be utilized in methods 200 is described below with reference to FIG. 4 and method 300.

Step 204 of method 200 includes receiving an attestation from the identified human creator claiming authorship of a particular work. For example, server-side software program(s) 118 may include one or more server-side creation attestation software programs 124 configured to facilitate the human creator providing a written and/or verbal attestation claiming authorship of the work without the use of synthetic generation tools, or in some cases, attesting to the use of synthetic generative tools in a reduced or secondary capacity. In some examples, client-side application(s) 110 are configured to display a certificate of authorship on user interface of client device 104 and the certificate of authorship includes a signature input field configured to receive an e-Signature from the human creator. In such examples, the human creator may provide a written attestation claiming authorship of the work by inputting signature data into the signature input field using user interface 112 of client device 104. In some examples, creation attestation software program(s) 124 are configured to transmit the certificate of authorship including the signature input field to client-side application(s) 110 and receive the certificate of authorship including the input signature data from client-side application(s) 110. The signed certificate of authorship connects the human creator that is validated by server-side identity validation program(s) 120 to the work. In some examples, the human creator provides a verbal attestation claiming authorship of the work without utilizing synthetic generation tools. In some examples, the human creator provides a verbal attestation that states which precise synthetic generation toolsets were used and how they were used. For example, the human creator may provide the verbal attestation during the video call conducted during the identity verification process discussed above. In some examples, provenance authentication system 100 is configured to store the signed certificate of authorship and/or the video including the verbal attestation from the human creator in a server-side database 126 of server 102.

Step 206 of method 200 includes analyzing the work to identify synthetic machine-generated elements or content in the work. For example, after the identity of the human creator is verified by identity validation program(s) 120 in step 202 and the human creator attests to having created the work without the use of synthetic machine-generation tools in step 204, one or more synthetic content identification software program(s) 122 of provenance authentication system 100 are configured to analyze the work itself to determine whether the work includes synthetic content.

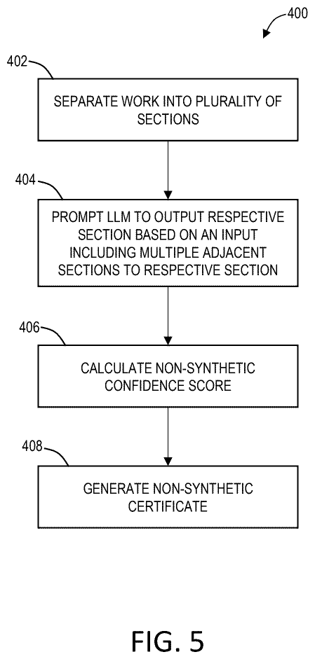

An example method of analyzing the work using an LLM to detect synthetically generated content is discussed below with reference to FIG. 5 and method 400. In addition to method 400 shown in FIG. 5, step 206 of method 200 may include utilizing cryptographic hashing to create a digital identifier (e.g., ISCC) of the work and attempting to match the digital identifier of the work against cryptographic hashes of existing works to detect possible plagiarism or re-use of existing content. In other words, step 206 of method 200 may include checking whether the work is derivative of existing works in addition to analyzing the work to detect synthetic or re-purposed elements. In some examples, step 206 of method 200 includes utilizing one or more trained machine learning models configured to analyze the work and detect synthetic generated content or re-purposed within the work. For example, synthetic content identification program(s) 122 of provenance authentication system 100 may include one or more trained machine learning models configured to distinguish between human-written works and synthetic generated writing and to further identify re-purposed content. In some examples, synthetic content identification program(s) 122 include one or more trained machine learning models configured to detect digital watermarks, meta data, and/or other any other suitable indicators of synthetic generated content or re-purposed content. The one or more trained machine learning models are configured to receive the work as input and detect digital watermarks, meta data, synthetic generated writing, synthetic generated images, and/or any other detectable patterns or indicators indicating that the creative work was created in whole or in part by generative machine systems.

One or all of the above described synthetic content identification program(s) 122 may be utilized to attempt to detect synthetic generated elements within the work in step 206 of method 200. The specific synthetic content identification program(s) 122 and/or methods utilized to analyze the work and detect synthetic generated content may be selected dependent on the type of work being analyzed, e.g., whether the work includes text, images, illustrations, music, audio, film, video, etc. In some examples, provenance authentication system 100 is configured to dynamically adjust the specific synthetic content identification program(s) 122 utilized in step 206 of method 200 based on the specific type of work being analyzed.

In some examples, step 206 of method 200 includes calculating one or more non-synthetic confidence scores indicating a likelihood that the work includes or does not include synthetic or artificially generated content. In some examples, multiple different non-synthetic confidence scores are output by each of the synthetic content identification program(s) 122 that are utilized in step 206 to detect the degree of synthetic content in the work. For example, a respective non-synthetic confidence score may be calculated based on the output of the LLM in comparison to the respective section as discussed further below with reference to FIG. 5, whether the cryptographic hash of the work matches or nearly matches the hash of any existing works, and/or the analysis of the work by the one or more trained machine learning models configured to detect synthetic generation patterns in the work. In some examples, a composite or overall non-synthetic confidence score is calculated based on the analysis performed by each of synthetic content identification program(s) 122 used to analyze the particular work. In some examples, synthetic content identification program(s) 122 are configured to generate a non-synthetic certificate certifying that the work does not include synthetic generated content.

Step 208 of method 200 includes analyzing a generative process of the work to determine whether the work was created using a human generative process. As discussed above with reference to FIG. 1, provenance authentication system 100 includes process tracking program(s) 127 configured to capture process data during the generative process of the work and determine whether the work was created using a human generative process. Natural persons have a distinct generative process in comparison to synthetic machine work-generation systems. For example, when generating works, natural persons exhibit some of these characteristics: irregular pacing, a non-linear generative process involving a large number of revisions, edits, and intermediate drafts, a greater number of grammatical errors and typos than synthetic generated content, and a greater number of changes in tone or perspective throughout a written work. This is a non-exhaustive list, but includes some of the attributes observed in the generative process employed by most natural persons. In contrast, synthetic generative engines typically create work in a linear fashion without a large number of corrections or errors and the output of a machine model (such as those found in an LLM) is typically always a completed version of the work. In step 208 of method 200, server-side software program(s) 118 are configured to analyze the generative process of the work to detect these differences and determine whether the work was created by a natural person.

In some examples, process tracking program(s) 127 include a word-processor tracking extension 128 configured to process data input into a word processor. In some examples, word-processor tracking extension 128 is a web-browser extension or plugin that is configured to capture data that is input into a browser-based word processor and/or any other suitable application utilized by the human creator to create the work. Alternatively, or additionally, provenance authentication system 100 may be configured to prompt a user to upload a plurality of intermediate drafts of the work onto client device 104 and client device 104 transmits the plurality of intermediate drafts to server(s) 102 for analysis.

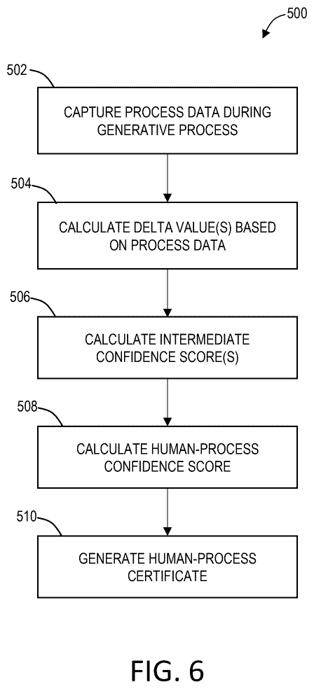

In step 208 of method 200, process tracking program(s) 127 are configured to utilize the process data (e.g., keystroke-level entry data and/or intermediate drafts) captured by word-processor tracking extension 128, and/or captured by any other suitable process tracking software program to determine whether a natural person is creating the work without reference to or use of synthetic generation tools. As discussed above with reference to FIG. 1, in some examples, process tracking program(s) 127 are configured to calculate one or more delta value(s) based on the captured generative process data. For example, as discussed above, process tracking program(s) 127 may calculate one or more textual delta values, semantic delta values, structural delta values, and/or chronological or temporal delta values based on the input generative process data. In some examples, step 208 of method 200 includes calculating a human-process confidence score for the work based on the delta values. The human-process confidence score indicates a likelihood that the work was created by a natural person without the use of synthetic generation tools based on the analysis of the generation process. An example process for performing step 208 of method 200 is described further below with reference to FIG. 6 and method 500.

Step 210 of method 200 includes use of a data profile to calculate a human-creation confidence score for the work. For example, the overall data profile which results in the confidence score may combine information from the results of validating the identity of the human creator in step 202, the analysis of the work performed in step 206, and the analysis of the generation process in step 208, server-side software program(s) 118 are configured to determine whether the human creator, who claims authorship of the work in step 204, is or was a natural person with a valid identity and determine whether the creative work itself was created by a natural person without the use of synthetic generation tools. In some examples, as discussed above, step 202 of method 200 includes calculating an identity-validation confidence score indicating a likelihood that the human creator is a natural person with a valid identity, step 206 of method 200 includes calculating a non-synthetic confidence score indicating a likelihood that the work does not include synthetic generated content, and/or step 208 of method 200 includes calculating a human-process confidence score which indicates the extent to which the generative process of the work is indicative of a human generative process. In some examples, the overall human-creation confidence is based in whole or in part on the non-synthetic confidence score, the human-process confidence scores, and/or the identity-validation confidence score. For example, the overall data profile which results in the human-creation confidence score may comprise a weighted average of the identity-validation confidence score, non-synthetic confidence score, and human-process confidence score.

Step 212 of method 200 includes generating a human-creation certificate which certifies that the human creator is a natural person with a valid identity and that the work is verified to be generated by a natural person without the use of synthetic generation tools. In some examples, based on the analysis performed in steps 202-208 of method 200 and/or the confidence score calculated in step 210, server-side software program(s) 118 are configured to certify the human creator as a natural person with a valid identity and/or the work as being human-created without the use of synthetic generation tools. For example, server-side software program(s) 118 may be configured to generate and output one or more certificates certifying the identity of the human creator and/or the work as being human-created without the use of synthetic generation tools. The one or more certificates generated by provenance authentication system 100 may be stored in server-side database 126 of server(s) 102 and/or transmitted to client device 104 of the human creator.

In some examples, provenance authentication system 100 is configured to generate one or more physical certificate objects certifying the human creator as a natural person having a valid identity and/or a work as being human-generated by the natural person without the use of machine generation tools. For example, provenance authentication system 100 may be configured to additively manufacture (e.g., 3D print) one or more physical certificate objects (e.g., tokens) and provide the physical certificate objects to the natural person creator of the work as a tangible proof-of-generation. Such physical certificate objects may be worn or displayed by the natural person creator, e.g., on necklaces, bracelets, frames around the work, attachments to the work, etc.

### C. Illustrative Method for Validating the Identity of a Human Creator

This section describes steps of an illustrative method 300 for validating the identity of a human creator as a natural person having a valid identity; see FIG. 4. Method 300 is an example process for performing step 202 of method 200, described above. Aspects of provenance authentication systems 100 described above may be utilized in the method steps described below. Where appropriate, reference may be made to components and systems that may be used in carrying out each step. These references are for illustration, and are not intended to limit the possible ways of carrying out any particular step of the method.

FIG. 4 is a flowchart illustrating steps performed in an illustrative method, and may not recite the complete process or all steps of the method. Although various steps of method 300 are described below and depicted in FIG. 4, the steps need not necessarily all be performed, and in some cases may be performed simultaneously or in a different order than the order shown.

Step 302 of method 300 includes receiving an identity documentation (e.g., a passport, driver's license, etc.) of the human creator (AKA natural person creator). For example, client-side software application(s) 110 may facilitate provenance authentication system 100 receiving the identity documentation by prompting the human creator to input a scan of the identity documentation via user interface 112. In some examples, client-side software application(s) 110 facilitate conducting a video call between the human creator and a certified individual and the human creator may display the identity documentation on camera during the video call. In some examples, client-side software application(s) 110 are configured to transmit the image(s) and/or scan(s) of the identity documentation to server-side software program(s) 118 for validation in step 304 of method 300.

Step 304 of method 300 includes validating the authenticity of the identity documentation received from the human creator. Server-side software program(s) 118 may be configured to validate the authenticity of the identity documentation in any suitable manner. For example, server-side software program(s) 118 may include one or more trained machine learning models (e.g., machine vision algorithms, natural language processing algorithms, etc.) that are configured to extract data from the identity documentation, analyze the data to detect any discrepancies with document-specific rules and/or regulations, and/or check the data against identity documentation data stored in one or more databases.

Step 306 of method 300 includes receiving or capturing biometric data of the human creator. The biometric data may include images, videos, facial scans, fingerprint scans, and/or any other suitable biometric data of the human creator that can be matched against data extracted from the identity documentation of the human creator. In some examples, client device 104 includes biometric sensor(s) 116 (e.g., a camera, fingerprint scanner, etc.) and step 306 includes capturing the required biometric data from the human creator using biometric sensor(s) 116. In some examples, client-side software application(s) 110 are configured to facilitate conducting a video call between the human creator and a certified individual and the biometric data includes images and/or video of the human creator captured by client device 104 during the video call. In some examples, client device 104 is configured to transmit the received or captured biometric data to server-side software program(s) 118 for further analysis.

Step 308 of method 300 includes comparing the biometric data captured or received in step 306 to information extracted from the identity documentation in steps 302 and 304. In some examples, provenance authentication system 100 includes one or more trained machine learning models (e.g., computer vision models) configured to analyze the biometric data (e.g., a facial scan of the human creator) and match the biometric data to data extracted from the identity documentation, such as an image of the human creator.

Step 310 of method 300 includes facilitating a video call between the human creator and a certified individual. As discussed above, in some examples, client-side application(s) 110 of provenance authentication system 100 are configured to facilitate a video call between the human creator and a certified individual. In such examples, the certified individual interacts with the human creator over the video call and may ask the human creator a series of questions, such as personal questions about the human creator(s) family or memories and/or questions about the work the human creator is attesting to have created, such as questions about the process of creating the work. The specific questions asked to the human creator are configured to illicit responses from the human creator, and the actions of the human creator during the interaction with the certified individual may be analyzed in step 312 discussed below to validate that the human creator is a natural person.

In some examples, steps 302, 304, 306, and/or 308 of method 300 are performed simultaneously or in conjunction with facilitating the video call in step 310. For example, the human creator may display on the video call the identity documentation of the human creator and the biometric data of the human creator may include images of the human creator captured during the video call. In some examples, during the video call, the human creator is asked to verbally attest to having created the work without using synthetic machine generation tools.

Step 312 of method 300 includes validating conversational data of the human creator captured during the video call in step 310. In some examples, client-side application(s) 110 and/or server-side software program(s) 118 are configured to analyze data captured during the video call (e.g., a video feed and/or audio from the video call) to validate that the human creator is a natural person having a valid identity. For example, client-side application(s) 110 and/or server-side software program(s) 118 may be configured to analyze the video feed of the human creator to detect human breathing, eye movement, heartbeat, etc. In some examples, client-side application(s) 110 and/or server-side software program(s) 118 are configured to analyze the human creator's speech and answers to the questions to validate that the human creator is a natural person. For example, server-side software program(s) 118 may be configured to receive the audio from the video call, transcribe the audio, and analyze the transcript to determine whether the answers given by the human creator indicate that the human creator is a natural person.

In some examples, client-side application(s) 110 are configured to facilitate and capture the video of the human creator and transmit the visual and/or audio data of the video call to server-side software program(s) 118 that perform the analysis. In some examples, server-side software program(s) 118 include computer vision models configured to analyze the video feed of the video call to detect human actions (e.g., breathing, eye movement, etc.) by the human creator, speech recognition models configured to convert speech into text, natural language processing models configured to analyze the text generated by the speech recognition models, and/or any other suitable machine learning models configured to facilitate verifying that the human creator is a natural person based on data captured during the video call.

In some examples, step 314 of method 300 includes receiving an attestation from the certified individual that the human creator is a natural person. For example, after conducting the interview with the human creator, the certified individual who conducted the interview may input an attestation claiming that the human creator was a natural person based on the interaction during the video call.

Step 316 of method 300 includes calculating an identity-validation confidence score indicating a likelihood that the human creator is a natural person having a valid identity. In some examples, server-side software program(s) 118 are configured to calculate the identity-validation confidence score based on the results of one or more of steps 302-314 of method 300. For example, the identity-validation confidence score may be based on whether the identity documentation is validated in step 304, the biometric data matches the information from the identity documentation in step 308, human actions (e.g., breathing, eye movement, etc.) and/or human speech are detected by server-side software program(s) 118 in step 312, and/or the certified individual attests to the human creator being a natural person.

In some examples, step 318 of method 300 includes generating an identity-validation certificate for the human creator certifying that the human creator is a natural person having a valid identity. For example, identity validation program(s) 120 may generate the identity-validation certificate in response to the identity-validation confidence score being above a threshold level and/or may include the identity-validation confidence score in the identity-validation certificate. In some examples, provenance authentication system 100 is configured to store the identity-validation certificate in a server-side database 126 of server(s) 102 and/or transmit the identity-validation certificate to client device 104 used by the human creator.

### D. Illustrative Method for Identifying Synthetic Generated Content

This section describes steps of an illustrative method 400 for identifying synthetic generated content within a work; see FIG. 5. Synthetic generated content, synthetic machine generated content, and the like as discussed herein may refer to content or elements of a work that are generated by a generative machine system, such as an LLM, and that are not generated by a natural person. Method 400 is an example process or algorithm that may be utilized to identify synthetic generated content within the work in step 206 of method 200, described above. Method 400 is one possible algorithm that may be utilized in step 206 of method 200 to identify synthetic generated content. In some examples, step 206 of method 200 includes performing method 400 in addition to one or more of the other algorithms or processes for detecting synthetic generated content that are discussed herein. Aspects of provenance authentication systems 100 described above may be utilized in the method steps described below. Where appropriate, reference may be made to components and systems that may be used in carrying out each step. These references are for illustration, and are not intended to limit the possible ways of carrying out any particular step of the method.

FIG. 5 is a flowchart illustrating steps performed in an illustrative method, and may not recite the complete process or all steps of the method. Although various steps of method 400 are described below and depicted in FIG. 5, the steps need not necessarily all be performed, and in some cases may be performed simultaneously or in a different order than the order shown.

Step 402 of method 400 includes separating a work into a plurality of sections. For example, server-side software program(s) 118 may be configured to separate a text-based work by word, sentence, paragraph, page, etc., such that each of the plurality of sections comprises a respective word, sentence, paragraph, or page of the text-based work.

Step 404 of method 400 includes prompting a large language model (LLM) to output a respective section of the plurality sections based on an input including multiple adjacent sections to the respective section without inputting the respective section itself. For example, a select one of the sections is chosen and one or more of the sections that directly precede the chosen section and one or more of the sections that directly follow the chosen section are input into the LLM. The chosen section itself is not input into the LLM. The LLM is prompted to output the chosen section based on the input adjacent sections. If the LLM is able to accurately output the chosen section based on the input adjacent sections, this may indicate that the chosen section was AI generated and/or plagiarized from an existing work. In some examples, the above-described process may be repeated for a plurality of the sections of the work to detect if any of the sections of the work are synthetically generated by an LLM.

Step 406 of method 400 includes calculating a non-synthetic confidence score based on the output of the LLM in step 404. The non-synthetic confidence score indicates a likelihood or a confidence level that the creative work does not include synthetically generated content. In some examples, the non-synthetic confidence score is dependent on how closely the output of the LLM matches the chosen section that the LLM is prompted to output in step 404. For example, in response to the output of the LLM exactly matching the chosen section, the non-synthetic confidence score may be decreased substantially and in response to the output of the LLM not closely matching the chosen section, the non-synthetic confidence score may be increased. As discussed above, in some examples, method 400 is utilized in conjunction with one or more additional algorithms and/or software programs to analyze the work to detect synthetically generated content in step 206 of method 200. In such examples, the non-synthetic confidence score calculated in step 406 may take into account the results of the analysis performed by the one or more additional algorithms and/or software programs of provenance authentication system 100 that are utilized to detect synthetically generated content in the work.

In some examples, step 408 of method 400 includes generating a non-synthetic certificate for the work certifying that no synthetically generated content was detected in the work. In some examples, the non-synthetic certificate includes the non-synthetic confidence score indicating the confidence level at which provenance authentication system 100 certifies that the creative work does not include AI generated content. In some examples, provenance authentication system 100 is configured to store the non-synthetic certificate in a server-side database 126 of server(s) 102 and/or transmit the non-synthetic certificate to client device 104.

### E. Illustrative Method for Tracking and Analyzing a Generative Process of a Work

This section describes steps of an illustrative method 500 for tracking and analyzing a generative process of a work; see FIG. 6. Method 500 is an example algorithm for performing step 208 of method 200, described above. Aspects of provenance authentication systems 100 described above may be utilized in the method steps described below. Where appropriate, reference may be made to components and systems that may be used in carrying out each step. These references are for illustration, and are not intended to limit the possible ways of carrying out any particular step of the method.

FIG. 6 is a flowchart illustrating steps performed in an illustrative method, and may not recite the complete process or all steps of the method. Although various steps of method 500 are described below and depicted in FIG. 6, the steps need not necessarily all be performed, and in some cases may be performed simultaneously or in a different order than the order shown.

Step 502 of method 500 includes capturing process data during a generative process of the work. In some examples, server-side software program(s) 118 of provenance authentication system 100 include one or more process tracking programs 127 that are configured to capture the process data during the generative process of the work. For example, process tracking program(s) 127 may be configured to capture one or more intermediate drafts of the work throughout the generative process. Alternatively, or additionally, provenance authentication system 100 may be configured to prompt a user to upload a plurality of intermediate drafts of the work for further analysis.

In some examples, step 502 is performed by a word-processor tracking extension or plug-in 128 configured to capture data input into a word processor as the work is generated by a natural person using the word processor. In some examples, word-processor tracking extension 128 is configured to capture keystroke-level entry data input by the human creator into the word processor. In some examples, word-processor tracking extension 128 is a web-browser extension or plugin that is configured to capture data that is input into a browser-based word processor.

The process data captured by word-processor tracking extension 128 may be temporarily stored locally on client device 104 before being transmitted by client device 104 to server(s) 102 for analysis in step 504. For example, the process data may be transmitted to server(s) 102 during client device 104 idle periods or at the completion of a work session. In some examples, the process data includes both the keystroke level input data and/or multiple distinct drafts or versions of the work. For example, a draft of the work may be captured at the end of each work session or workday. The generative process for the work may include a plurality of the work sessions or work days each having corresponding process data that may be captured and stored in server-side database(s) 126 to create a record of creation for the work including the keystroke-level entry data, the plurality of intermediate drafts of the creative work corresponding to the different work sessions, and/or any other suitable process data captured by word-processor tracking extension 128.

Step 504 of method 500 includes calculating one or more delta values based on the process data captured in step 502. Each delta value may be calculated using different algorithms. For example, server-side software program(s) 118 may calculate one or more textual delta values, semantic delta values, structural delta values, and/or chronological or temporal delta values based on the input data captured in step 502.

In some examples, step 504 of method 500 includes calculating one or more textual delta values which indicate a level of variation between successive drafts of the work at the character level, word level, sentence level, and/or paragraph level. For example, server-side software program(s) 118 may utilize the Levenshtein distance algorithm and/or Myers difference algorithm to calculate character level variation between successive drafts of the work, the Jaccard similarity coefficient to determine a word-level variation between successive drafts, and/or utilize the Smith-Waterman algorithm to calculate sentence-level variation between successive drafts. Any other suitable algorithms may be utilized to calculate the textual delta value(s) between the captured intermediate drafts of the work.

In some examples, step 504 of method 500 includes calculating one or more semantic delta values which indicate semantic drift or meaning changes of the work throughout the generative process. In some examples, server-side software program(s) 118 are configured to utilize transformer embeddings (e.g., BERT or ROBERTa) to generate document vectors for each of multiple successive drafts of the work and calculate the cosine similarity between the different drafts using the generated document vectors. This process may be repeated a plurality of times throughout the generative process of the work to measure semantic drift of the work throughout the generative creation process.

In some examples, step 504 of method 500 includes calculating one or more structural delta values based on the process data captured in step 502. The structural delta value(s) may be calculated in any suitable manner and may be utilized to track or quantify paragraph reorganization, formatting changes, citation additions, and/or punctuation changes throughout the generative process. In some examples, server-side software program(s) 118 are configured to compare the structural delta value(s) for the work to structural delta value(s) that are calculated for known human-created work and/or structural delta value(s) that are calculated for known synthetic generated work to determine whether the structural changes made to the work throughout the generative process indicate generation by a natural person or generation by a generative machine system.

In some examples, step 504 of method 500 further includes in addition to calculating the one or more delta values determining a temporal fingerprint of the work on one or more of the work sessions and/or over an entirety of the generative process. For example, typing velocity variance, pause distributions (e.g., the time distribution between user inputs), revision timing and/or the number of revisions, and/or any other suitable variables may be determined and utilized to generate the temporal fingerprint for the work. The human writing process tends to include irregular pacing including bursts of data, followed by thinking or reversing and editing previously input data. In contrast, synthetic machine systems such as language modeling systems exhibit consistent generation speed with minimal reversals and editing. As a result, the temporal fingerprint of the work is a useful tool in determining whether a natural person or a generative machine system is creating the work.

In some examples, step 504 of method 500 includes calculating one or more chronological or temporal delta value(s). In some examples, the one or more chronological delta value(s) quantify differences in typing patterns, edits, pause distributions, etc. at different times during the creation process of the work. For example, differences between the typing patterns on different workdays may be compared to identify discrepancies. If the typing patterns vary widely between different workdays throughout the generative process and/or are similar to typing patterns exhibited by language modeling systems, the generative process for the work may be identified as potentially showing evidence of synthetic generation.

In some examples, step 506 of method 500 includes calculating one or more intermediate confidence scores, which are configured to be utilized in step 508 of method 500 to calculate an overall human-process confidence score. For example, the one or more intermediate confidence scores may include a temporal-fingerprint score, a revision-pattern score, an error-analysis score, and/or a stylistic-variance score. In some examples, the intermediate confidence scores are calculated based on one or more of the delta values calculated in step 504.

In some examples, step 506 of method 500 includes calculating a temporal-fingerprint score. The temporal-fingerprint score indicates whether the typing patterns and/or temporal fingerprint for the generative process are indicative of creation by a natural person. In some examples, the temporal-fingerprint score is calculated based on the temporal fingerprint and/or the chronological delta values calculated in step 504.

In some examples, step 506 of method 500 further includes calculating the revision-pattern score that indicates the extent to which the work was created in a non-linear fashion. For example, if the generative process of the work includes multiple incomplete drafts and revisions and reversals of previous versions throughout the generative process, the revision-pattern score may indicate a high likelihood that the work was generated by a natural person. The revision-pattern score may be based in whole or in part on the textual delta value(s), semantic delta value(s), structural delta value(s), and/or temporal fingerprint(s) of the work calculated in step 504.

In some examples, step 506 of method 500 includes calculating the error-analysis score of the work indicating whether the number of grammatical errors and/or typos included in the work is indicative of generation by a natural person. Natural persons typically generate more grammatical errors and typos than synthetic machine systems. The error-analysis score may be calculated based on the number of errors present in the finished work and/or multiple error-analysis scores may be calculated based on the intermediate drafts of the work.

In some examples, step 506 of method 500 includes calculating the stylistic-variance score for the work based on changes in tone, voice, etc., throughout the work. Human creators tend to switch tone or point of view throughout a work more often than synthetic machine systems, which usually maintain a consistent voice. Server-side software program(s) 118 may be configured to detect changes in tone and/or point of view throughout the work and calculate the stylistic-variance score based on the quantity of tone and perspective switches in the creative work.

Step 508 of method 500 includes calculating an overall human-process confidence score based on the one or more delta values and/or confidence scores discussed above. The human-process confidence score indicates a likelihood that the work was created by a natural person based on the analysis of the human generative process performed in steps 504 and 506. In some examples, the overall human-process confidence score is a weighted sum of the temporal-fingerprint score, revision-pattern score, error-analysis score, stylistic-variance score, and/or any other suitable confidence scores. In some examples, greater weight may be given to one or more of the intermediate confidence scores. For example, greater weight may be given to the temporal-fingerprint score and/or revision-pattern score in comparison to the error-analysis score and stylistic-variance score. In some examples, method 500 does not include calculating the intermediate confidence score(s) in step 506 and the overall human-process confidence score is calculated directly based on the delta value(s) calculated in step 504 of method 500.

In some examples, method 500 includes step 510 including generating a human-process certificate certifying that the work was created by a natural person based on the analysis of the generative process in steps 502-508. In some examples, the human-process certificate includes the human-process confidence score calculated in step 508. In some examples, provenance authentication system 100 is configured to store the human-process certificate in a server-side database 126 of server(s) 102 and/or transmit the human-process certificate to client device 104.

### F. Illustrative Data Processing System

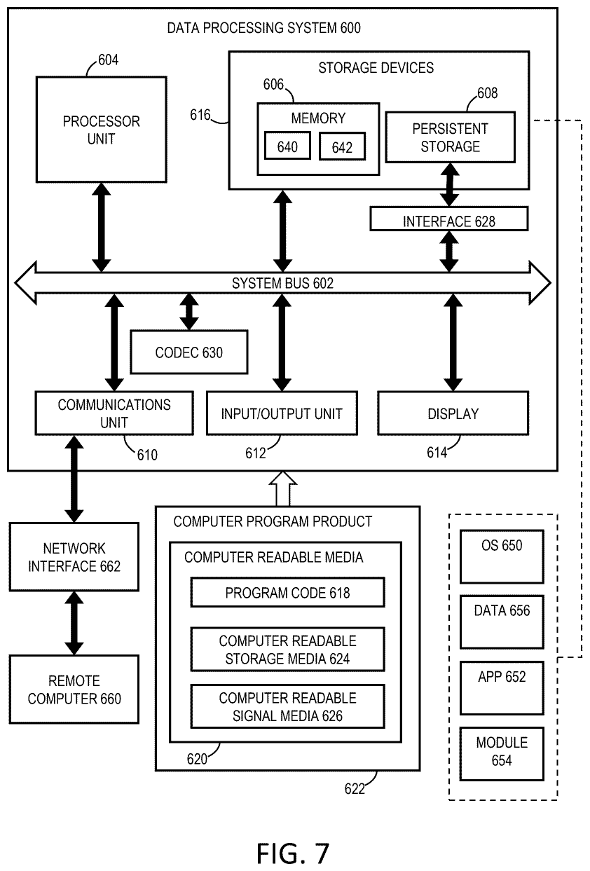

As shown in FIG. 7, this example describes a data processing system 600 (also referred to as a computer, computing system, and/or computer system) in accordance with aspects of the present disclosure. In this example, data processing system 600 is an illustrative data processing system suitable for implementing aspects of provenance authentication system 100. More specifically, in some examples, devices that are embodiments of data processing systems (e.g., smartphones, tablets, personal computers) may include client device(s) 104 and/or server(s) 102 of provenance authentication system 100.

In this illustrative example, data processing system 600 includes a system bus 602 (also referred to as communications framework). System bus 602 may provide communications between a processor unit 604 (also referred to as a processor or processors), a memory 606, a persistent storage 608, a communications unit 610, an input/output (I/O) unit 612, a codec 630, and/or a display 614. Memory 606, persistent storage 608, communications unit 610, input/output (I/O) unit 612, display 614, and codec 630 are examples of resources that may be accessible by processor unit 604 via system bus 602.

Processor unit 604 serves to run instructions that may be loaded into memory 606. Processor unit 604 may comprise a number of processors, a multi-processor core, and/or a particular type of processor or processors (e.g., a central processing unit (CPU), graphics processing unit (GPU), etc.), depending on the particular implementation. Further, processor unit 604 may be implemented using a number of heterogeneous processor systems in which a main processor is present with secondary processors on a single chip. As another illustrative example, processor unit 604 may be a symmetric multi-processor system containing multiple processors of the same type.

Memory 606 and persistent storage 608 are examples of storage devices 616. A storage device may include any suitable hardware capable of storing information (e.g., digital information), such as data, program code in functional form, and/or other suitable information, either on a temporary basis or a permanent basis.

Storage devices 616 also may be referred to as computer-readable storage devices or computer-readable media. Memory 606 may include a volatile storage memory 640 and a non-volatile memory 642. In some examples, a basic input/output system (BIOS), containing the basic routines to transfer information between elements within the data processing system 600, such as during start-up, may be stored in non-volatile memory 642. Persistent storage 608 may take various forms, depending on the particular implementation.

Persistent storage 608 may contain one or more components or devices. For example, persistent storage 608 may include one or more devices such as a magnetic disk drive (also referred to as a hard disk drive or HDD), solid state disk (SSD), floppy disk drive, tape drive, Jaz drive, Zip drive, flash memory card, memory stick, and/or the like, or any combination of these. One or more of these devices may be removable and/or portable, e.g., a removable hard drive. Persistent storage 608 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 608 to system bus 602, a removable or non-removable interface is typically used, such as interface 628.

Input/output (I/O) unit 612 allows for input and output of data with other devices that may be connected to data processing system 600 (i.e., input devices and output devices). For example, an input device may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 604 through system bus 602 via interface port(s). Suitable interface port(s) may include, for example, a serial port, a parallel port, a game port, and/or a universal serial bus (USB).

One or more output devices may use some of the same types of ports, and in some cases the same actual ports, as the input device(s). For example, a USB port may be used to provide input to data processing system 600 and to output information from data processing system 600 to an output device. One or more output adapters may be provided for certain output devices (e.g., monitors, speakers, and printers, among others) which require special adapters. Suitable output adapters may include, e.g. video and sound cards that provide a means of connection between the output device and system bus 602. Other devices and/or systems of devices may provide both input and output capabilities, such as remote computer(s) 660. Display 614 may include any suitable human-machine interface or other mechanism configured to display information to a user, e.g., a CRT, LED, or LCD monitor or screen, etc.

Communications unit 610 refers to any suitable hardware and/or software employed to provide for communications with other data processing systems or devices. While communication unit 610 is shown inside data processing system 600, it may in some examples be at least partially external to data processing system 600. Communications unit 610 may include internal and external technologies, e.g., modems (including regular telephone grade modems, cable modems, and DSL modems), ISDN adapters, and/or wired and wireless Ethernet cards, hubs, routers, etc. Data processing system 600 may operate in a networked environment, using logical connections to one or more remote computers 660. A remote computer(s) 660 may include a personal computer (PC), a server, a router, a network PC, a workstation, a microprocessor-based appliance, a peer device, a smart phone, a tablet, another network note, and/or the like. Remote computer(s) 660 typically include many of the elements described relative to data processing system 600. Remote computer(s) 660 may be logically connected to data processing system 600 through a network interface 662 which is connected to data processing system 600 via communications unit 610. Network interface 662 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 630 may include an encoder, a decoder, or both, comprising hardware, software, or a combination of hardware and software. Codec 630 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 630 is depicted as a separate component, codec 630 may be contained or implemented in memory, e.g., non-volatile memory 642.

Non-volatile memory 642 may include read only memory (ROM), programmable ROM (PROM), electrically programmable ROM (EPROM), electrically erasable programmable ROM (EEPROM), flash memory, and/or the like, or any combination of these. Volatile memory 640 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 616, which are in communication with processor unit 604 through system bus 602. In these illustrative examples, the instructions are in a functional form in persistent storage 608. These instructions may be loaded into memory 606 for execution by processor unit 604. Processes of one or more embodiments of the present disclosure may be performed by processor unit 604 using computer-implemented instructions, which may be located in a memory, such as memory 606.

These instructions are referred to as program instructions, program code, computer usable program code, or computer-readable program code executed by a processor in processor unit 604. The program code in the different embodiments may be embodied on different physical or computer-readable storage media, such as memory 606 or persistent storage 608. Program code 618 may be located in a functional form on computer-readable media 620 that is selectively removable and may be loaded onto or transferred to data processing system 600 for execution by processor unit 604. Program code 618 and computer-readable media 620 form computer program product 622 in these examples. In one example, computer-readable media 620 may comprise computer-readable storage media 624 or computer-readable signal media 626.

Computer-readable storage media 624 may include, for example, an optical or magnetic disk that is inserted or placed into a drive or other device that is part of persistent storage 608 for transfer onto a storage device, such as a hard drive, that is part of persistent storage 608. Computer-readable storage media 624 also may take the form of a persistent storage, such as a hard drive, a thumb drive, or a flash memory, that is connected to data processing system 600. In some instances, computer-readable storage media 624 may not be removable from data processing system 600.

In these examples, computer-readable storage media 624 is a non-transitory, physical or tangible storage device used to store program code 618 rather than a medium that propagates or transmits program code 618. Computer-readable storage media 624 is also referred to as a computer-readable tangible storage device or a computer-readable physical storage device. In other words, computer-readable storage media 624 is media that can be touched by a person.

Alternatively, program code 618 may be transferred to data processing system 600, e.g., remotely over a network, using computer-readable signal media 626. Computer-readable signal media 626 may be, for example, a propagated data signal containing program code 618. For example, computer-readable signal media 626 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 618 may be downloaded over a network to persistent storage 608 from another device or data processing system through computer-readable signal media 626 for use within data processing system 600. For instance, program code stored in a computer-readable storage medium in a server data processing system may be downloaded over a network from the server to data processing system 600. The computer providing program code 618 may be a server computer, a client computer, or some other device capable of storing and transmitting program code 618.

In some examples, program code 618 may comprise an operating system (OS) 650. Operating system 650, which may be stored on persistent storage 608, controls and allocates resources of data processing system 600. One or more applications 652 take advantage of the operating system's management of resources via program modules 654, and program data 656 stored on storage devices 616. OS 650 may include any suitable software system configured to manage and expose hardware resources of computer 600 for sharing and use by applications 652. In some examples, OS 650 provides application programming interfaces (APIs) that facilitate connection of different type of hardware and/or provide applications 652 access to hardware and OS services.

In some examples, certain applications 652 may provide further services for use by other applications 652, e.g., as is the case with so-called “middleware.” Aspects of present disclosure may be implemented with respect to various operating systems or combinations of operating systems.

The different components illustrated for data processing system 600 are not meant to provide architectural limitations to the manner in which different embodiments may be implemented. One or more embodiments of the present disclosure may be implemented in a data processing system that includes fewer components or includes components in addition to and/or in place of those illustrated for computer 600. Other components shown in FIG. 7 can be varied from the examples depicted. Different embodiments may be implemented using any hardware device or system capable of running program code. As one example, data processing system 600 may include organic components integrated with inorganic components and/or may be comprised entirely of organic components (excluding a natural person). For example, a storage device may be comprised of an organic semiconductor.

In some examples, processor unit 604 may take the form of a hardware unit having hardware circuits that are specifically manufactured or configured for a particular use, or to produce a particular outcome or progress. This type of hardware may perform operations without needing program code 618 to be loaded into a memory from a storage device to be configured to perform the operations. For example, processor unit 604 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 618) may be implemented as hardware, e.g., by specifying an FPGA configuration using a hardware description language (HDL) and then using a resulting binary file to (re) configure the FPGA.

In another example, data processing system 600 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In still another illustrative example, processor unit 604 may be implemented using a combination of processors found in computers and hardware units. Processor unit 604 may have a number of hardware units and a number of processors that are configured to run program code 618. With this depicted example, some of the processes may be implemented in the number of hardware units, while other processes may be implemented in the number of processors.

In another example, system bus 602 may comprise one or more buses, such as a system bus or an input/output bus. Of course, the bus system may be implemented using any suitable type of architecture that provides for a transfer of data between different components or devices attached to the bus system. System bus 602 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 610 may include a number of devices that transmit data, receive data, or both transmit and receive data. Communications unit 610 may be, for example, a modem or a network adapter, two network adapters, or some combination thereof. Further, a memory may be, for example, memory 606, or a cache, such as that found in an interface and memory controller hub that may be present in system bus 602.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

### G. Illustrative Distributed Data Processing System

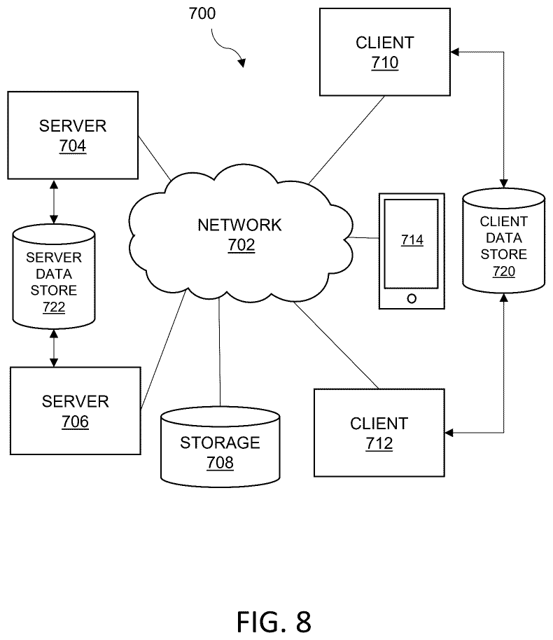

As shown in FIG. 8, this example describes a general network data processing system 700, interchangeably termed a computer network, a network system, a distributed data processing system, or a distributed network, which may be included in one or more illustrative embodiments of provenance authentication system 100. For example, client device(s) 104 and server(s) 102 may communicate with each other over a computer network.

It should be appreciated that FIG. 8 is provided as an illustration of one implementation and is not intended to imply any limitation with regard to environments in which different embodiments may be implemented. Many modifications to the depicted environment may be made.

Network system 700 is a network of devices (e.g., computers), each of which may be an example of data processing system 600, and other components. Network data processing system 700 may include network 702, which is a medium configured to provide communications links between various devices and computers connected within network data processing system 700. Network 702 may include connections such as wired or wireless communication links, fiber optic cables, and/or any other suitable medium for transmitting and/or communicating data between network devices, or any combination thereof.

In the depicted example, a first network device 704 and a second network device 706 connect to network 702, as do one or more computer-readable memories or storage devices 708. Network devices 704 and 706 are each examples of data processing system 600, described above. In the depicted example, devices 704 and 706 are shown as server computers, which are in communication with one or more server data store(s) 722 that may be employed to store information local to server computers 704 and 706, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 710 and 712 and/or a client smart device 714, may connect to network 702. Each of these devices is an example of data processing system 600, described above regarding FIG. 7. Client electronic devices 710, 712, and 714 may include, for example, one or more personal computers, network computers, and/or mobile computing devices such as personal digital assistants (PDAs), smart phones, handheld gaming devices, wearable devices, and/or tablet computers, and the like. In the depicted example, server 704 provides information, such as boot files, operating system images, and applications to one or more of client electronic devices 710, 712, and 714. Client electronic devices 710, 712, and 714 may be referred to as “clients” in the context of their relationship to a server such as server computer 704. Client devices may be in communication with one or more client data store(s) 720, which may be employed to store information local to the clients (e,g., cookie(s) and/or associated contextual information). Network data processing system 700 may include more or fewer servers and/or clients (or no servers or clients), as well as other devices not shown.

In some examples, first client electric device 710 may transfer an encoded file to server 704. Server 704 can store the file, decode the file, and/or transmit the file to second client electric device 712. In some examples, first client electric device 710 may transfer an uncompressed file to server 704 and server 704 may compress the file. In some examples, server 704 may encode text, audio, and/or video information, and transmit the information via network 702 to one or more clients.

Client smart device 714 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 700 may be stored in or on a computer-readable storage medium, such as network-connected storage device 708 and/or a persistent storage 608 of one of the network computers, as described above, and may be downloaded to a data processing system or other device for use. For example, program code may be stored on a computer-readable storage medium on server computer 704 and downloaded to client 710 over network 702, for use on client 710. In some examples, client data store 720 and server data store 722 reside on one or more storage devices 708 and/or 608.

Network data processing system 700 may be implemented as one or more of different types of networks. For example, system 700 may include an intranet, a local area network (LAN), a wide area network (WAN), or a personal area network (PAN). In some examples, network data processing system 700 includes the Internet, with network 702 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 702 may be referred to as a “cloud.” In those examples, each server 704 may be referred to as a cloud computing node, and client electronic devices may be referred to as cloud consumers, or the like. FIG. 8 is intended as an example, and not as an architectural limitation for any illustrative embodiments.

### H. Illustrative Combinations and Additional Examples

This section describes additional aspects and features of systems and methods for authenticating the provenance of work, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.
A0. A system for authenticating provenance of a work, the system comprising:
   a server including a server memory and one or more server processors;
   a client device in communication with the server over a communication network; and
   a software program including a plurality of instructions stored in the server memory and executable by the one or more server processors to:
validate an identity of a natural person creator;
receive an attestation from the natural person creator claiming authorship of the work; and
determine whether the work is human-created without use of synthetic machine work-generation tools, wherein determining whether the work is human-created includes:
   analyzing the work to identify indicators of synthetic machine generation; and
   analyzing a generative process of the work to identify indicators of a human generative process of the work.
A1. The system of paragraph A0, wherein the client device includes a biometric sensor configured to capture biometric data of the natural person creator.
A1.1. The system of paragraph A1, wherein the biometric sensor comprises a facial recognition sensor.
A1.2. The system of paragraph A1 or A1.1, wherein the one or more server processors are further configured to:
receive the biometric data and an image of an identity documentation of the natural person creator from the client device; and
compare the biometric data to information in the identity documentation; and
in response to the biometric data matching the information in the identity documentation, positively validating the natural person creator as a natural person having a valid identity.
A1.3. The system of paragraph A1.2, wherein the one or more server processors are further configured to generate an identity-validation certificate certifying the identity of the natural person creator in response to the biometric data matching the information in the identity documentation.
A2. The system of any one of paragraphs A0-A1.3, wherein the system further comprises a video camera operatively connected to the client device, wherein the video camera is configured to capture a video of the natural person creator.
A2.1. The system of paragraph A2, wherein the one or more server processors are further configured to:
detect activity of the natural person creator in the video captured by the video camera; and
verify the natural person creator is a natural person based on the detected activity.
A2.2. The system of paragraph A2.1, wherein detecting activity of the natural person creator comprises detecting one or more of breathing, eye movement, heartbeat, and/or speech of the natural person creator in the video.
A2.3. The system of any one of paragraphs A0-A2.2, wherein the attestation received from the natural person creator comprises a verbal attestation given by the natural person creator in the video captured by the video camera.
A3. The system of any one of paragraphs A0-A2.2, wherein the attestation received from the natural person creator comprises an e-Signature.
A4. The system of any one of paragraphs A0-A3, wherein analyzing the work to identify indicators of synthetic machine generation by the one or more server processors includes:
separating the work into a plurality of sections;
for a respective section of the plurality of sections, prompting a large language model (LLM) to attempt to output the respective section based on an input including multiple adjacent sections to the respective section without inputting the respective section itself; and
determining whether the respective section is synthetically generated based on the output of the LLM.
A4.1. The system of paragraph A4, wherein if the output of the LLM matches the respective section, the respective section is determined to be synthetically generated.
A4.2. The system of paragraph A4 or A4.1, wherein the one or more server processors are further configured to calculate a non-synthetic confidence score based on a comparison between the output of the LLM and the respective section, wherein the non-synthetic confidence score indicates a likelihood the respective section is synthetically generated by a synthetic machine work-generation tool.
A5. The system of any one of paragraphs A0-A4.2, wherein analyzing the work to identify indicators of synthetic generation by the one or more server processors includes using one or more trained machine learning models configured to receive the work as input and detect one or more of the indicators of synthetic machine generation within the work.
A5.1. The system of paragraph A5, wherein the one or more trained machine learning models are configured to output a/the non-synthetic confidence score indicating a likelihood of the work including synthetic machine generated content.
A5.2. The system of paragraph A5 or A5.1, wherein the one or more indicators of synthetic machine generation include meta data and watermarks embedded in the work.
A6. The system of any one of paragraphs A0-A5.2, further comprising a word-processor extension including a plurality of extension instructions stored in the server memory and configured to be executed by the one or more server processors to:
capture generative process data input into a word processor during a generative process of the work;
calculate one or more delta values based on the generative process data; and
determine whether the delta values indicate the work was generated by a natural person using the human generative process.
A6.1. The system of paragraph A6, wherein calculating the one or more delta values includes calculating one or more of a textual delta value, a semantic delta value, a structural delta value, and/or a chronological delta value, wherein each of the one or more delta values is calculated utilizing one or more respective algorithms.
A6.2. The system of paragraph A6.1, wherein the generative process data includes multiple intermediate drafts of the work, and wherein calculating the textual delta value includes utilizing one or more of the Myers difference algorithm, the Levenshtein distance algorithm, the Jacaard similarity coefficient, and/or the Smith-Waterman algorithm to calculate a difference between the multiple intermediate drafts.
A6.3. The system of any one of paragraphs A6.1-A6.2, wherein the generative process data includes multiple intermediate drafts of the work, and wherein calculating the semantic delta value includes using transformer embeddings to generate a respective document vector for each of the multiple intermediate drafts, and calculating a cosine similarity between each of the multiple intermediate drafts using the respective document vector of each of the multiple intermediate drafts.
A6.4. The system of any one of paragraphs A6-A6.3, wherein the generative process data includes keystroke-level input data input into the word processor, and wherein the one or more server processors are further configured to determine a temporal fingerprint, wherein the temporal fingerprint includes typing velocity variance throughout the generative process, a pause distribution throughout the generative process, and a revision-timing distribution throughout the generative process.
A6.5. The system of any one of paragraphs A6-A6.4, wherein determining whether the delta values indicate the work was generated by the natural person using the human generative process includes calculating a human-process confidence score based on the one or more delta values, wherein the human-process confidence score indicates a likelihood that the work was generated by the natural person using the human generative process.
A6.6. The system of any one of paragraphs A6-A6.5, wherein the word-processor tracking extension is a web-browser extension configured to capture data input into a browser-based word processor.
A7. The system of any one of paragraphs A0-A6.6, wherein the one or more server processors are further configured to calculate a human-creation confidence score based on the analysis of the work to identify indicators of synthetic machine generation and the analysis of the generative process of the work.
A7.1. The system of paragraph A6, wherein in response to positively validating the identity of the natural person creator, receiving the attestation from the natural person creator, and the human-creation confidence score meeting a threshold level, the one or more server processors are further configured to generate a human-creation document certifying creation of the work by the natural person creator without the use of synthetic machine work-generation tools.
A8. The system of any one of paragraphs A0-A7.1, wherein the work comprises one or more of text, images, illustrations, music, audio, film, and video.
A9. The system of any one of paragraphs A0-A7.1, wherein in response to positively validating the identity of the natural person creator, receiving the attestation from the natural person creator, and determining the work is human-created without use of synthetic machine work-generation tools, the system is further configured to generate a physical human-creation token certifying generation of the work by the natural person creator without the use of synthetic machine work-generation tools.
A9.1. The system of paragraph A9, wherein generating the physical human-creation token includes additively manufacturing (e.g., 3D printing) the physical human-creation token.
B0. A method of authenticating provenance of a work, implemented in a data processing system, the method comprising:
utilizing one or more processors of the data processing system to:
   validate an identity of a natural person creator;
   receive an attestation from the natural person creator claiming authorship of the work; and
   determine whether the work is human-created without the use of synthetic machine work-generation tools by:
      analyzing the work to identify indicators of synthetic machine generation; and
      analyzing a generative process of the work to identify indicators of a human generative process of the work.
B1. The method of paragraph B0, wherein validating the identity of the natural person creator comprises:
receiving a scan of an identity documentation; and
validating an authenticity of the identity documentation.
B1.1. The method of paragraph B1, further comprising:
receiving biometric data of the natural person creator; and
comparing the biometric data to information in the identity documentation.
B1.2. The method of paragraph B1.1, wherein the biometric data and the information in the identity documentation each include a respective image of the natural person creator.
B1.3. The method of paragraph B1.1 or B1.2, further comprising:
in response to the biometric data matching the information in the identity documentation, generating an identity-validation certificate certifying the natural person creator as a natural person having a valid identity.
B2. The method of any one of paragraphs B0-B1.3, wherein validating the identity of the natural person creator comprises capturing a video of the natural person creator using a video camera during a questioning process.
B2.1. The method of paragraph B2, further comprising:
detecting activity of the natural person creator in the video of the natural person creator; and
verifying the natural person creator is a natural person based on the detected activity.
B2.2. The method of paragraph B2.1, wherein detecting activity of the natural person creator comprises detecting one or more of breathing, eye movement, heartbeat, and speech of the natural person creator in the video.
B2.3. The method of any one of paragraphs B0-B2.2, wherein the attestation received from the natural person creator comprises a verbal attestation given by the natural person creator in the video.
B3. The method of any one of paragraphs B0-B2.3, wherein the attestation from the natural person creator comprises an e-Signature.
B4. The method of any one of paragraphs B0-B3, wherein analyzing the work to identify indicators of synthetic machine generation comprises:
separating the work into a plurality of sections;
for a respective section of the plurality of sections, prompting a large language model (LLM) to attempt to output the respective section based on an input including multiple adjacent sections to the respective section without inputting the respective section itself; and
determining whether the respective section is synthetically generated based on the output of the LLM.
B4.1. The method of paragraph B4, further comprising determining the respective section is synthetically generated in response to the output of the LLM matching the respective section.
B4.2. The method of paragraph B4 or B4.1, further comprising calculating a non-synthetic confidence score for the respective section based on a comparison between the output of the LLM and the respective section, wherein the non-synthetic confidence score indicates a likelihood the respective section is synthetically generated by a synthetic machine generation tool.
B5. The method of any one of paragraphs B0-B4.2, further comprising inputting the work into one or more trained machine learning models configured to detect one or more of the indicators of synthetic machine generation within the work.
B5.1. The method of paragraph B5, wherein the one or more trained machine learning models are configured to output a/the non-synthetic confidence score indicating a likelihood of the work including synthetic machine generated content.
B5.2. The method of paragraph B5 or B5.1, wherein the one or more indicators of synthetic machine generation include meta data and watermarks embedded in the creative work.
B6. The method of any one of paragraphs B0-B5.1, further comprising:
capturing generative process data input into a word processor during a generative process of the work;
calculating one or more delta values based on the generative process data; and
determining whether the delta values indicate the work was created by a natural person using the human generative process.
B6.1. The method of paragraph B6, wherein calculating the one or more delta values includes calculating one or more of a textual delta value, a semantic delta value, a structural delta value, and/or a chronological delta value, wherein each of the one or more delta values is calculated utilizing one or more respective algorithms.
B6.2. The method of paragraph B6.1, wherein the generative process data includes multiple intermediate drafts of the work, and wherein calculating the textual delta value includes utilizing one or more of the Myers difference algorithm, the Levenshtein distance algorithm, the Jacaard similarity coefficient, and the Smith-Waterman algorithm to calculate a difference between the multiple intermediate drafts.
B6.3. The method of any one of paragraphs B6.1-B6.2, wherein the generative process data includes multiple intermediate drafts of the work, and wherein calculating the semantic delta value includes using transformer embeddings to generate a respective document vector for each of the multiple intermediate drafts, and calculating a cosine similarity between each of the multiple intermediate drafts using the respective document vector of each of the multiple intermediate drafts.
B6.4. The method of any one of paragraphs B6-B6.3, further comprising determining a temporal fingerprint based on the generative process data, wherein the temporal fingerprint includes typing velocity variance throughout the generative process, a pause distribution throughout the generative process, and a revision-timing distribution throughout the generative process.
B6.5. The method of any one of paragraphs B6-B6.4, wherein determining whether the delta values indicate the work was created by the natural person using the human generative process includes calculating a human-process confidence score based on the one or more delta values, wherein the human-process confidence score indicates a likelihood that the work was generated by the natural person using the human generative process.
B6.6. The method of any one of paragraphs B6-B6.5, wherein capturing the generative process data includes utilizing a word-processor tracking extension including a plurality of instructions stored in a memory of the data processing system and configured to be executed by the one or more processors to capture the generative process data input into a browser-based word processor.
B7. The method of any one of paragraphs B0-B6.6, further comprising calculating a human-creation confidence score based on the analysis of the work to identify indicators of synthetic generation and the analysis of the generative process.
B7.1. The method of paragraph B7, further comprising in response to positively validating the identity of the natural person creator, receiving the attestation from the natural person creator, and the human-creation confidence score meeting a threshold level, generating a human-creation certificate certifying creation of the work by the natural person creator without use of synthetic generation tools.
B8. The method of any one of paragraphs B0-B7.1, wherein the work comprises one or more of text, images, illustrations, music, audio, film, and video.

### Advantages, Features, and Benefits

The different embodiments and examples of the provenance authentication systems and methods described herein provide several advantages over known solutions. For example, illustrative embodiments and examples described herein provide a system that reliably and accurately certifies a work as being genuinely human-created by not only verifying the absence of synthetic generated content within the work, but also capturing and identifying evidence of human creation, such as detecting a human generative process (e.g., draft-revision process) of the work. In this manner, the system is not only able to identify works that are synthetically generated by A1 systems or other machine driven systems, but also positively identify content that is verifiably human-created or human-generated.

Additionally, and among other benefits, illustrative embodiments and examples described herein allow a word-processor tracking extension or plug-in that is configured to capture keystroke-level data input into a word processor used to create a written work. The system includes one or more software programs and/or algorithmic tools configured to analyze the keystroke-level input data to determine whether a natural person is inputting the data to create the work or whether generative synthetic systems are being utilized to generate the work in question. By tracking the generative process of the work, the system is able to positively verify that the work was created by a natural person.

Additionally, and among other benefits, illustrative embodiments and examples described herein allow for the generation of documents that attest to human creation for a human creator of a work. Such documentation of human creation certifies that the system was able to validate the identity of the human creator and that the system determined that the work was created by a human without the use of synthetic generation tools.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A system for authenticating provenance of a work, the system comprising:
a server including a server memory and one or more server processors;
a client device in communication with the server over a communication network; and
a software program including a plurality of instructions stored in the server memory and executable by the one or more server processors to:
validate an identity of a natural person creator;
receive an attestation from the natural person creator claiming authorship of the work; and
determine whether the work is human-created without use of synthetic machine work-generation toolsets, wherein determining whether the work is human-created includes:
analyzing the work to identify indicators of synthetic machine generation; and
analyzing a generative process of the work to identify indicators of a human generative process of the work.

2. The system of claim 1, wherein the client device includes a biometric sensor configured to capture biometric data of the natural person creator.

3. The system of claim 2, wherein the one or more server processors are further configured to:
receive the biometric data and an image of an identity documentation of the natural person creator from the client device;
compare the biometric data to information in the identity documentation; and
in response to the biometric data matching the information in the identity documentation, validating the natural person creator as a natural person having a valid identity.

4. The system of claim 1, wherein the system further comprises a video camera configured to capture a video of the natural person creator.

5. The system of claim 4, wherein the one or more server processors are further configured to analyze the video of the natural person creator to:
detect activity of the natural person creator in the video captured by the video camera; and
verify the natural person creator is a natural person based on the detected activity.

6. The system of claim 1, wherein analyzing the work to identify indicators of synthetic machine generation by the one or more server processors includes:
separating the work into a plurality of sections;
for a respective section of the plurality of sections, prompting a large language model (LLM) to attempt to output the respective section based on an input including multiple adjacent sections to the respective section without inputting the respective section itself; and
determining whether the respective section is synthetically generated based on the output of the LLM.

7. The system of claim 1, wherein analyzing the work to identify indicators of synthetic machine generation by the one or more server processors includes using one or more trained machine learning models configured to receive the work as input and detect one or more of the indicators of synthetic machine generation within the work.

8. The system of claim 7, wherein the one or more of the indicators of synthetic machine generation include meta data and watermarks embedded in the work.

9. The system of claim 1, further comprising a word-processor tracking extension including a plurality of word-processor extension instructions stored in the server memory and configured to be executed by the one or more server processors to:
capture generative process data input into a word processor during the generative process of the work;
calculate one or more delta values based on the generative process data; and
determine whether the one or more delta values indicate the work was generated by a natural person using the human generative process.

10. The system of claim 9, wherein the word-processor tracking extension is a web-browser extension configured to capture data input into a browser-based word processor.

11. The system of claim 1, wherein the one or more server processors are further configured to calculate a human-creation confidence score based on analyzing the work to identify indicators of synthetic machine generation and analyzing the generative process of the work.

12. The system of claim 11, wherein in response to positively validating the identity of the natural person creator, receiving the attestation from the natural person creator, and the human-creation confidence score meeting a threshold level, the one or more server processors are further configured to generate a human-creation document certifying creation of the work by the natural person creator without use of synthetic machine work-generation toolsets.

13. A method of authenticating provenance of a work, implemented in a data processing system, the method comprising:
utilizing one or more processors of the data processing system to:
validate an identity of a natural person creator;
receive an attestation from the natural person creator claiming authorship of the work; and
determine whether the work is human-created without the use of synthetic machine work-generation tools by:
analyzing the work to identify indicators of synthetic machine generation; and
analyzing a generative process of the work to identify indicators of a human generative process of the work.

14. The method of claim 13, wherein analyzing the work to identify indicators of synthetic machine generation comprises:
separating the work into a plurality of sections;
for a respective section of the plurality of sections, prompting a large language model (LLM) to attempt to output the respective section based on an input including multiple adjacent sections to the respective section without inputting the respective section itself; and
determining whether the respective section is synthetically generated based on the output of the LLM.

15. The method of claim 14, further comprising determining the respective section is synthetically generated in response to the output of the LLM matching the respective section.

16. The method of claim 13, further comprising inputting the work into one or more trained machine learning models configured to detect one or more of the indicators of synthetic machine generation within the work.

17. The method of claim 16, wherein the one or more of the indicators of synthetic machine generation include meta data and watermarks embedded in the work.

18. The method of claim 13, further comprising:
capturing generative process data input into a word processor during a generative process of the work;
calculating one or more delta values based on the generative process data; and
determining whether the delta values indicate the work was generated by a natural person using the human generative process.

19. The method of claim 13, further comprising calculating a human-creation confidence score based on analyzing the work to identify indicators of synthetic machine generation and analyzing the generative process.

20. The method of claim 19, further comprising in response to positively validating the identity of the natural person creator, receiving the attestation from the natural person creator, and the human-creation confidence score meeting a threshold level, generating a human-creation document certifying generation of the work by the natural person creator without use of synthetic machine generation tools.
